(19) United States
(12) Patent Application Publication
(10) Pub. No.: US 2019/0219856 A1
(43) Pub. Date: Jul. 18, 2019

(54) LIQUID CRYSTAL PANEL, SWITCHABLE MIRROR PANEL AND SWITCHABLE MIRROR DISPLAY

(71) Applicant: SHARP KABUSHIKI KAISHA, Sakai City, Osaka (JP)

(72) Inventors: Masanobu MIZUSAKI, Sakai City (JP); Hiroyuki HAKOI, Sakai City (JP)

(73) Assignee: SHARP KABUSHIKI KAISHA, Sakai City, Osaka (JP)

(21) Appl. No.: 16/305,872

(22) PCT Filed: May 24, 2017
(86) PCT No.: PCT/JP2017/019296

§ 371 Date: Nov. 29, 2018

(30) Foreign Application Priority Data
May 31, 2016 (JP) 2016-109025

(51) Int. Cl. G02F 1/133; G02F 1/1337; G02F 1/1335

(52) U.S. Cl. CPC G02F 1/13306; G02F 1/1337; G02F 1/133514; G02F 1/133602; G02F 1/133553

(57) ABSTRACT

The present invention provides a liquid crystal panel that achieves low-voltage driving and wide color gamut and suppresses the generation of residual DC voltage caused by UV light included in backlight illumination or the like, a switchable mirror panel including the liquid crystal panel, and a switchable mirror display including the liquid crystal panel. The liquid crystal panel of the present invention includes: a first substrate; a second substrate; a liquid crystal layer held between the first substrate and the second substrate; and a vertical alignment film disposed on a liquid crystal layer side of each of the first substrate and the second substrate. The liquid crystal layer contains a liquid crystal material with a negative anisotropy of dielectric constant. The liquid crystal material contains a tolan liquid crystal compound. The vertical alignment film contains a vertical alignment polymer that includes a main chain and a side chain. The side chain includes a saturated aliphatic functional group at a terminal.

### TECHNICAL FIELD

The present invention relates to liquid crystal panels, switchable mirror panels, and switchable mirror displays. Specifically, the present invention relates to, in a switchable mirror display configured to switch (to be switchable) between the display mode and the mirror mode, a liquid crystal panel suitably provided in a switchable mirror panel for switching between the display mode and the mirror mode, a switchable mirror panel including the liquid crystal panel, and a switchable mirror display including the switchable mirror panel.

### BACKGROUND ART

Recently, liquid crystal display devices have been rapidly spread and employed in wide applications such as e-books, photo-frames, industrial appliances, personal computers (PCs), tablet computers, and smart phones, in addition to television applications. Liquid crystal display devices have been required to have various properties in such wide applications, and thus various modes for liquid crystal displays have been developed.

Concerning liquid crystal panels (hereinafter, also referred to as “liquid crystal cells”) used for liquid crystal display devices, Patent Literature 1 discloses a method of producing a homeotropic liquid crystal cell with stable alignment, including doping a first negative dielectric anisotropy liquid crystal material with at least one of positive, neutral, and second negative dielectric anisotropy liquid crystal materials. Patent Literature 1 also discloses, in Table 5, a negative liquid crystal material having a birefringence (Δn) of 0.19 or more and an anisotropy of dielectric constant (Δε) of −3.2 or less.

In addition, switchable mirror displays for digital signage or the like applications have been proposed which include a half mirror layer on the viewing surface side of a display device to function as a mirror and is configured to be switchable between the display mode and the mirror mode. Such switchable mirror displays provide images using display light emitted from the display devices and are also used as mirrors by reflecting external light. For example, Patent Literature 2 discloses a display device including a stack of a lighting device 100, a liquid crystal display panel 200 providing images (including an absorptive polarizing plate 208), a reflective polarizing plate 300, a transmissive polarization axis variable portion 400, and an absorptive polarizing plate 500. The transmissive polarization axis variable portion 400 can select one of a state of converting incident linearly polarized light, when it passes through the variable portion, into “linearly polarized light” whose polarization axis is perpendicular to that in the initial polarization state and a state of not converting the polarization state of the polarized light. In the examples, a twisted nematic (TN) liquid crystal element is disclosed as an example.

In the state of providing an image, the transmissive polarization axis variable portion 400 converts incident linearly polarized light into perpendicular polarized light. External light 3002 is thus not reflected by the reflective polarizing plate 300 and reflection or reduction in contrast ratio (FIG. 10 in Patent Literature 2) hardly occurs. In the state of a mirror, the transmissive polarization axis variable portion 400 maintains the polarization state of incident linearly polarized light. External light 3002 is thus reflected by the reflective polarizing plate 300 and the display device serves as a mirror (FIG. 11 in Patent Literature 2).

### CITATION LIST

### Patent Literature

Patent Literature 1: JP 2006-301643 A
Patent Literature 2: JP 3419766 B

### SUMMARY OF INVENTION

### Technical Problem

A switchable mirror display is a liquid crystal display device that includes, in the following order from the back surface side, a backlight, a first liquid crystal panel emitting polarized light, and a second liquid crystal panel utilizing the birefringence. When the first liquid crystal panel provides an image, the second liquid crystal panel is brought to a transparent state to allow display of the image (display mode). When the first liquid crystal panel provides no image, the birefringence of liquid crystal in the second liquid crystal panel is controlled to allow color reflective display (mirror mode). The substrates constituting the first liquid crystal panel each include an absorptive polarizing plate. The back surface side substrate constituting the second liquid crystal panel includes a reflective polarizing plate, while the viewer side substrate includes an absorptive polarizing plate. The second liquid crystal panel varies the birefringence (retardation) of liquid crystal by applying voltage to the liquid crystal to control the amount of transmitting light (transmittance). With the fact that the birefringence at which the transmittance is maximum differs between different wavelengths, color reflective display is achieved without a color filter.

The above switchable mirror display is required to achieve low-voltage driving and wide color gamut. Thus, for the second liquid crystal panel, a negative liquid crystal material having a high birefringence (Δn) and a high anisotropy of dielectric constant (Δε) is suitably employed. Examples of such a negative liquid crystal material include a liquid crystal material containing a tolan liquid crystal compound as disclosed in Patent Literature 1.

Unfortunately, the tolan liquid crystal compound includes a triple bond between carbon atoms. Thus, as shown in the following Formula 1, a n bond of the triple bond is easily cleaved by UV light included in backlight illumination or the like to generate radicals in the liquid crystal layer. The radicals generated by the n bond cleavage are electrical impurities having a half charge of an ion, and some radicals are ionized.

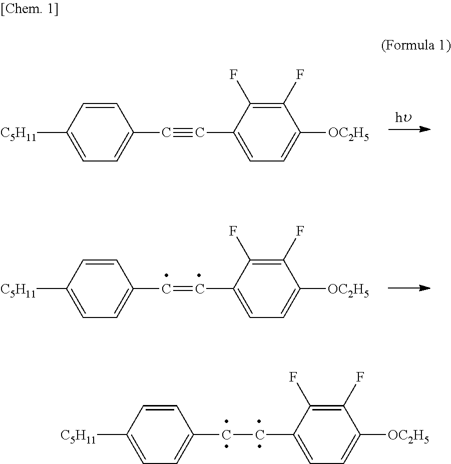

A compound containing a triple bond between carbon atoms such as a tolan liquid crystal compound, which includes two n bonds, is more likely to generate radicals than a compound including a double bond between carbon atoms. Accordingly, even with passive driving with rectangular wave voltage application, applying a slight DC offset causes generation of radicals and ions in the liquid crystal layer containing the tolan liquid crystal compound. These radicals and ions move to a surface of an alignment film and some of them adsorb on the surface of the alignment film. This resultantly generates residual DC voltage to cause display unevenness such as image sticking.

Patent Literature 1 fails to disclose a method for suppressing the generation of residual DC voltage in a liquid crystal panel containing a tolan liquid crystal compound. In addition, the mirror display of Patent Literature 2, which employs a liquid crystal element utilizing the rotatory polarization of polarized light (e.g., TN mode liquid crystal element) for a transmissive polarization axis variable portion, fails in imparting color(s) to reflective external light in the mirror mode, which can be achieved by a switchable mirror display. Furthermore, there is no description of use of a tolan liquid crystal compound for a liquid crystal element or a method of suppressing residual DC voltage generated in use of a tolan liquid crystal compound.

The present invention has been made under the current situation in the art and aims to provide a liquid crystal panel that achieves low-voltage driving and wide color gamut and suppresses the generation of residual DC voltage caused by UV light included in backlight illumination or the like, a switchable mirror panel including the liquid crystal panel, and a switchable mirror display including the liquid crystal panel.

### Solution to Problem

The present inventors made various studies on liquid crystal panels that achieve low-voltage driving and wide color gamut and suppress the generation of residual DC voltage caused by UV light included in backlight illumination or the like and focused on a combination of a liquid crystal material and a vertical alignment film. The inventors then found that using a tolan liquid crystal compound and a vertical alignment film and providing a saturated aliphatic functional group at a side chain terminal of a vertical alignment polymer in the vertical alignment film can suppress the n-n interaction between the tolan liquid crystal compound including radicals and ions and the vertical alignment film, thereby suppressing the generation of residual DC voltage. Thus, the inventors successfully solved the problem to arrive at the present invention.

In other words, an aspect of the present invention may be a liquid crystal panel including: a first substrate; a second substrate; a liquid crystal layer held between the first substrate and the second substrate; and a vertical alignment film disposed on a liquid crystal layer side of each of the first substrate and the second substrate, the liquid crystal layer containing a liquid crystal material with a negative anisotropy of dielectric constant, the liquid crystal material containing a tolan liquid crystal compound, the vertical alignment film containing a vertical alignment polymer that includes a main chain and a side chain, the side chain including a saturated aliphatic functional group at a terminal.

The tolan liquid crystal compound may be a compound represented by a formula (T).

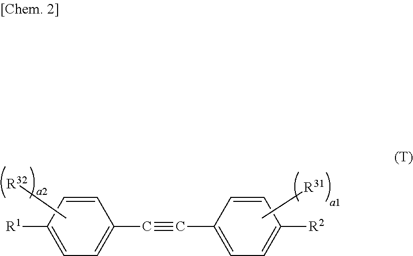

In the formula, R¹ and R² are each independently a group represented by —(O)_{b}—R⁴; R³¹ and R³² are each independently a halogen group; R⁴ is a C1-C40 aliphatic group, a C6-C40 aromatic group, a cyano group, or an isothiocyanate group; a1 and a2 are each independently an integer of 0 to 4; and b is 0 or 1.

In the formula (T), R¹ and R² may each be independently —CH₃, —C₂H₅, —C₃H₇, —C₄H₉, —C₅H₁₁, —C₆H₁₃, —OCH₃, —OC₂H₅, —OC₃H₇, —OC₄H₉, —OC₅H₁₁, —OC₆H₁₃, —C₂H₄CH═CH₂, or —OC₂H₄CH═CH₂; R³¹ and R³² may each be independently a fluorine atom; and a1 and a2 may each be independently an integer of 0 to 2.

The tolan liquid crystal compound may be at least one selected from the group consisting of liquid crystal compounds represented by formulas (T-1) to (T-5).

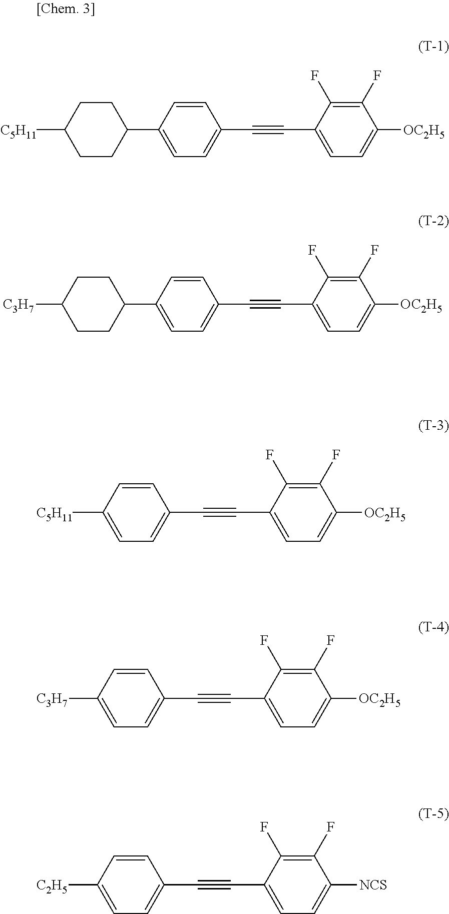

The liquid crystal material may have a birefringence Δn of 0.18 or higher and an anisotropy of dielectric constant Δε of −2.5 or lower.

The side chain of the vertical alignment polymer may include at least one selected from the group consisting of groups represented by formulas (ZA-1) to (ZA-8).

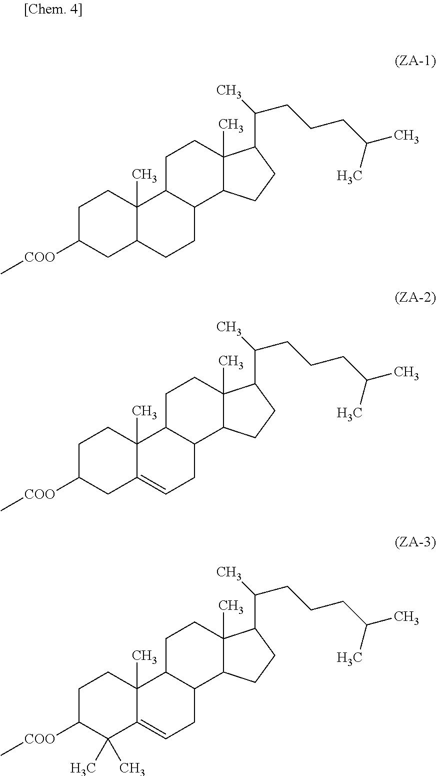

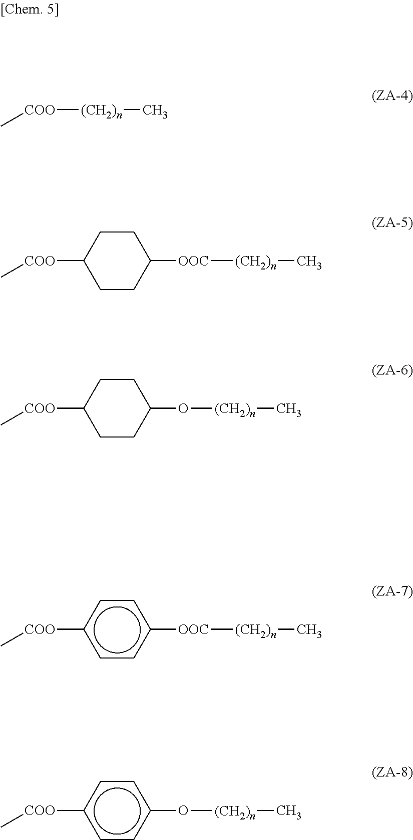

In the formulas, n may be an integer of 1 to 17, and the hydrogen atoms are each optionally replaced by a halogen group.

The main chain of the vertical alignment polymer may include a polyamic acid, a polyimide, a polysiloxane, or polyvinyl.

The vertical alignment film may be a photoalignment film.

The side chain of the vertical alignment polymer may include at least one selected from the group consisting of cinnamate, azobenzene, chalcone, coumarin, and stilbene groups.

The liquid crystal panel may be a passive driving liquid crystal panel.

Another aspect of the present invention may be a switchable mirror panel including, in a following order from a back surface side to a front surface side: a reflective polarizing plate; the liquid crystal panel; and an absorptive polarizing plate, the switchable mirror panel being capable of switching between a transparent mode of transmitting light incident on the reflective polarizing plate from the back surface side through the absorptive polarizing plate and a mirror mode of reflecting light incident on the absorptive polarizing plate from the front surface side by the reflective polarizing plate.

A still another aspect of the present invention may be a switchable mirror display including, in a following order from a back surface side to a front surface side: a backlight; a liquid crystal display part; and the switchable mirror panel, the liquid crystal display part including an active substrate, a color filter substrate, a liquid crystal layer held between the active substrate and the color filter substrate, and a polarizing plate disposed on a side opposite to the liquid crystal layer of each of the active substrate and the color filter substrate.

### Advantageous Effects of Invention

The present invention can provide a liquid crystal panel that achieves low-voltage driving and wide color gamut and suppresses the generation of residual DC voltage caused by UV light included in backlight illumination or the like, a switchable mirror panel including the liquid crystal panel, and a switchable mirror display including the liquid crystal panel.

### BRIEF DESCRIPTION OF DRAWINGS

FIG. 1 is a schematic cross-sectional view of a liquid crystal panel of Embodiment 1.

FIG. 2 is a schematic cross-sectional view of a switchable mirror panel of Embodiment 2.

FIG. 3 is a schematic cross-sectional view of a switchable mirror display of Embodiment 3.

FIG. 4 is a conceptual view of the switchable mirror display of Embodiment 3.

FIGS. 5(1) to 5(6) are drawings showing the polarization states of a switchable mirror display of Example 4: FIG. 5(1) is a drawing concerning a front surface side absorptive polarizing plate of a switchable mirror panel; FIG. 5(2) is a drawing concerning a liquid crystal panel of the switchable mirror panel; FIG. 5(3) is a drawing concerning a back surface side reflective polarizing plate of the switchable mirror panel; FIG. 5(4) is a drawing concerning a front surface side absorptive polarizing plate of a liquid crystal display part; FIG. 5(5) is a drawing concerning a FFS-mode liquid crystal panel for display of the liquid crystal display part; and FIG. 5(6) is a drawing concerning a back surface side absorptive polarizing plate of the liquid crystal display part.

### DESCRIPTION OF EMBODIMENTS

The present invention is described below in more detail based on embodiments with reference to the drawings. The embodiments, however, are not intended to limit the scope of the present invention. The configurations employed in the embodiments may appropriately be combined or modified within the spirit of the present invention.

### Embodiment 1

### <Liquid Crystal Panel>

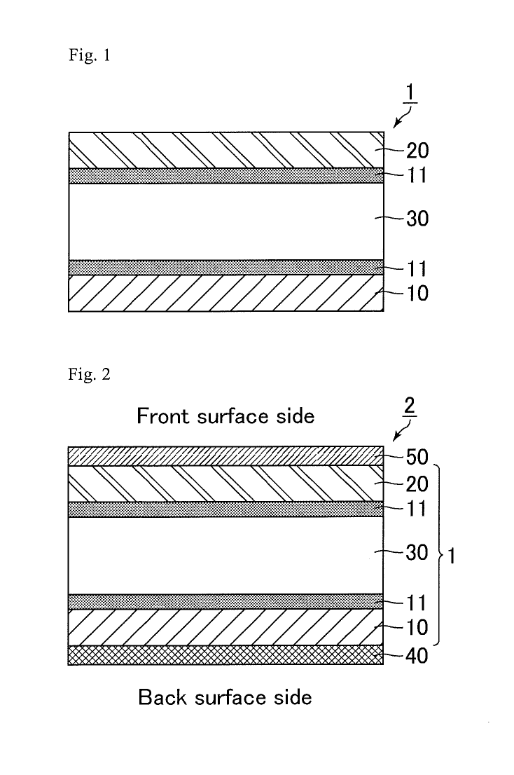

FIG. 1 is a schematic cross-sectional view of a liquid crystal panel of Embodiment 1. As shown in FIG. 1, a liquid crystal panel 1 of the present embodiment includes a first substrate 10, a second substrate 20, a liquid crystal layer 30 held between the first substrate 10 and the second substrate 20, and vertical alignment films 11 disposed on the liquid crystal layer 30 side of the first substrate 10 and of the second substrate 20.

### <Substrate>

The first substrate 10 and the second substrate 20 each include a transparent substrate, and at least one of the first substrate 10 and the second substrate 20 includes an electrode. Examples of the transparent substrate include a glass substrate and a plastic substrate.

### <Liquid Crystal Layer>

The liquid crystal layer 30 includes a liquid crystal material with a negative anisotropy of dielectric constant (also referred to as a negative liquid crystal material). The liquid crystal material contains a tolan liquid crystal compound. The term tolan is a trivial name of 1,2-diphenylacetylene. A tolan liquid crystal compound is a collective term of liquid crystal compounds that contain tolan as a skeleton of a molecular structure. The tolan liquid crystal compound has a low viscosity, a high birefringence (Δn), and stability to the heat of a nematic phase. Use of a liquid crystal material containing the tolan liquid crystal compound can provide a negative liquid crystal material having an anisotropy of dielectric constant (Δε) with a large absolute value and a high birefringence (Δn).

The tolan liquid crystal compound is preferably a liquid crystal compound represented by the formula (T).

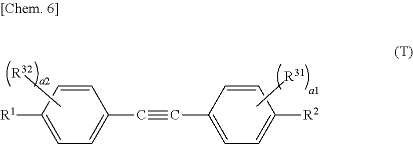

In the formula, R¹ and R² are each independently a group represented by —(O)_{b}—R⁴; R³¹ and R³² are each independently a halogen group; R⁴ is a C1-C40 aliphatic group, a C6-C40 aromatic group, a cyano group, or an isothiocyanate group; a1 and a2 are each independently an integer of 0 to 4; and b is 0 or 1.

In the formula (T), preferably, R¹ and R² are each independently —CH₃, —C₂H₅, —C₃H₇, —C₄H₉, —C₅H₁₁, —C₆H₁₃, —OCH₃, —OC₂H₅, —OC₃H₇, —OC₄H₉, —OC₅H₁₁, —OC₆H₁₃, —C₂H₄CH═CH₂, or —OC₂H₄CH═CH₂.

In the formula (T), R³¹ and R³² are each independently a halogen group. Examples of the halogen group include fluorine, chlorine, and bromine atoms, preferably a fluorine atom. The signs a1 and a2 are each independently an integer of 0 to 4, preferably an integer of 0 to 2.

R⁴ is preferably a C1-C18 aliphatic group or an isothiocyanate group.

In the formula (T), preferably, R¹ and R² are each independently —CH₃, —C₂H₅, —C₃H₇, —C₄H₉, —C₅H₁₁, —C₆H₁₃, —OCH₃, —OC₂H₅, —OC₃H₇, —OC₄H₉, —OC₅H₁₁, —OC₆H₁₃, —C₂H₄CH═CH₂, or —OC₂H₄CH═CH₂; R³¹ is a fluorine atom; a1 is 0 or 2; and a2 is 0. This improves the compatibility between the tolan liquid crystal compound and other liquid crystal compound(s) in the liquid crystal material and thereby enables use of the liquid crystal material usable as a liquid crystal layer in a wider temperature range.

The tolan liquid crystal compound is preferably at least one selected from the group consisting of the liquid crystal compounds represented by the formulas (T-1) to (T-5). The liquid crystal compounds represented by the formulas (T-1) to (T-4) have a negative anisotropy of dielectric constant and may be suitably used for a vertical alignment mode. The liquid crystal compound represented by the formula (T-5) contains an isothiocyanate group and thus can increase the positive anisotropy of dielectric constant and the refractive index anisotropy (birefringence).

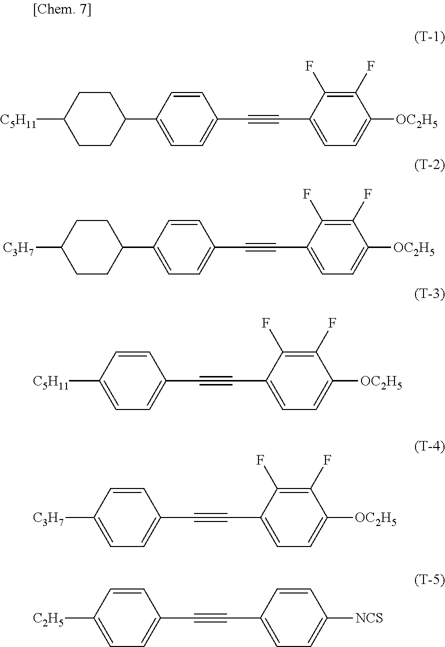

The liquid crystal material with a negative anisotropy of dielectric constant has a birefringence (Δn) of preferably 0.18 or higher, more preferably 0.19 or higher, still more preferably 0.20 or higher. The liquid crystal material has an anisotropy of dielectric constant (Δε) of preferably −2.5 or lower, more preferably −3.0 or lower, still more preferably −3.3 or lower.

The liquid crystal material preferably has a birefringence of 0.18 or higher and an anisotropy of dielectric constant of −2.5 or lower, more preferably a birefringence of 0.19 or higher and an anisotropy of dielectric constant of −3.0 or lower, still more preferably a birefringence of 0.20 or higher and an anisotropy of dielectric constant of −3.3 or lower.

A liquid crystal material with a negative anisotropy of dielectric constant having a birefringence and an anisotropy of dielectric constant falling within the above ranges can be more suitably used for a liquid crystal display device that is required to achieve low-voltage driving and wide color gamut.

The anisotropy of dielectric constant (Δε) is defined by the following formula (L):

Δε=(dielectric constant in the major axis direction)−(dielectric constant in the minor axis direction) (L).

The anisotropy of dielectric constant (Δε) of the liquid crystal material can be determined by forming a horizontally or vertically aligned liquid crystal cell and calculating the dielectric constants in the major axis direction and in the minor axis direction from the capacitance values before and after high voltage application. The birefringence (Δn) of the liquid crystal material can be measured with an Abbe refractometer.

The liquid crystal material may contain another liquid crystal compound in addition to the tolan liquid crystal compound. The amount W of the tolan liquid crystal compound in the liquid crystal material is preferably 0 wt % <W≤30 wt %. A larger amount of the tolan liquid crystal compound can increase the birefringence. However, more than 30 wt % of the tolan liquid crystal compound causes radical generation, possibly deteriorating the reliability due to factors such as an increase in residual DC voltage.

### <Vertical Alignment Film>

The vertical alignment films 11 control the alignment of the liquid crystal compound in the liquid crystal layer 30. When the voltage applied to the liquid crystal layer 30 is under the threshold voltage (including no voltage application), the major axis of the liquid crystal compound in the liquid crystal layer 30 is controlled to align substantially vertically to the surface of the vertical alignment film. In this state (hereinafter, also referred to as initial alignment state), an angle formed by the major axis of the liquid crystal compound with respect to each surface of the substrates 10 and 20 is called a “pre-tilt angle”. The “pre-tilt angle” herein means an angle of the inclination of the liquid crystal compound observed from the direction parallel to the substrate surfaces, and the angle parallel to the substrate surfaces is defined as 0° while the angle of the normal line to the substrate surface is defined as 90°

In the present embodiment, the pre-tilt angle is preferably 85° or more and 90° or less. Thus, the present embodiment is particularly preferably employed for a vertical alignment mode.

The method of the alignment treatment of the vertical alignment films 11 is not particularly limited and examples include rubbing treatment and photoalignment treatment.

The rubbing treatment is performed by rotating a roller wrapped with cloth such as nylon on the substrates 10 and 20 coated with the vertical alignment films 11 with a constant pressure to rub the surfaces of the vertical alignment films 11 in one direction.

The photoalignment treatment is performed by irradiating a photoalignment film formed of a material having a photoalignment property with linearly polarized UV light, thereby selectively changing the structure of the photoalignment film in the polarized direction. Δε a result, the photoalignment film has anisotropy and liquid crystal molecules have alignment azimuths. The material having a photoalignment property encompasses all the materials whose structure is changed by irradiation with light (electromagnetic waves) such as UV light and visible light to control the alignment (to exhibit alignment controlling force) of liquid crystal molecules in the vicinity of the material or to change the strength or direction of the alignment controlling force. Examples of the material having a photoalignment property include those including a photoreactive site that causes a reaction such as dimerization (dimer formation), isomerization, photo-Fries rearrangement, and decomposition by light irradiation.

Examples of the photoreactive site (functional group) that causes dimerization and isomerization by light irradiation include cinnamate, chalcone, coumarin, and stilbene. Examples of the photoreactive site (functional group) that causes isomerization by light irradiation include azobenzene. Examples of the photoreactive site that causes photo-Fries rearrangement by light irradiation include phenol ester structures. Examples of the photoreactive site that causes decomposition by light irradiation include cyclobutane structures.

The vertical alignment films 11 are preferably photoalignment films that can be subjected to photoalignment treatment. More preferably, the vertical alignment films 11 include a vertical alignment polymer whose side chain includes at least one selected from the group consisting of cinnamate, azobenzene, chalcone, coumarin, and stilbene groups. Using photoalignment films for the vertical alignment films 11 can prevent streaky display unevenness and static electricity that are caused by use of vertical alignment films for rubbing treatment.

The vertical alignment films 11 contain a vertical alignment polymer including a main chain and a side chain, and the side chain contains a saturated aliphatic functional group at a terminal. The structure that a side chain terminal of the vertical alignment polymer contains a saturated aliphatic functional group inhibits the n-n interaction between the vertical alignment films 11 and radicals and ions of the tolan liquid crystal compound, which are generated by irradiation with UV light included in a backlight or the like, thereby suppressing residual DC voltage.

A side chain of the vertical alignment polymer is preferably represented by —(R^{Z})_{d}—(COO—Z)ₑ or —(R^{Z})_{d}—(OCO—Z)ₑ. In the formulas, R^{Z} is a C1-C5 group with a valence of e+1, d is 0 or 1, e is 1 or 2, Z has a cyclic structure and is a C15-C30 group containing a saturated aliphatic functional group at a terminal.

Specific examples of the group represented by —(R^{Z})_{d}—(COO—Z)ₑ or —(R^{Z})_{d}—(OCO—Z)ₑ include groups represented by the following formulas (ZA-1) to (ZA-8) and (ZB-1) to (ZB-21). When the vertical alignment films 11 undergo rubbing treatment, the groups represented by the formulas (ZA-1) to (ZA-8) are preferred. When the vertical alignment films 11 undergo photoalignment treatment, the groups represented by the formulas (ZB-1) to (ZB-21) are preferred. At least one hydrogen atom contained in each structure may be replaced by a halogen, methyl, or ethyl group. Particularly, the hydrogen atom(s) in (ZA-4) to (ZA-8) may be replaced by a fluorine atom.

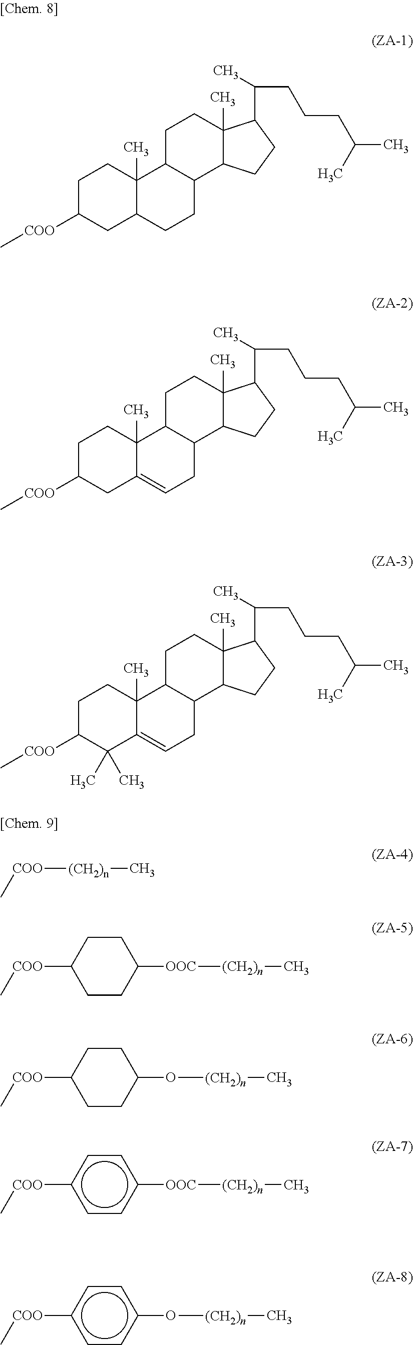

In the formulas, n is an integer of 1 to 17, and hydrogen atoms are each optionally replaced by a halogen group.

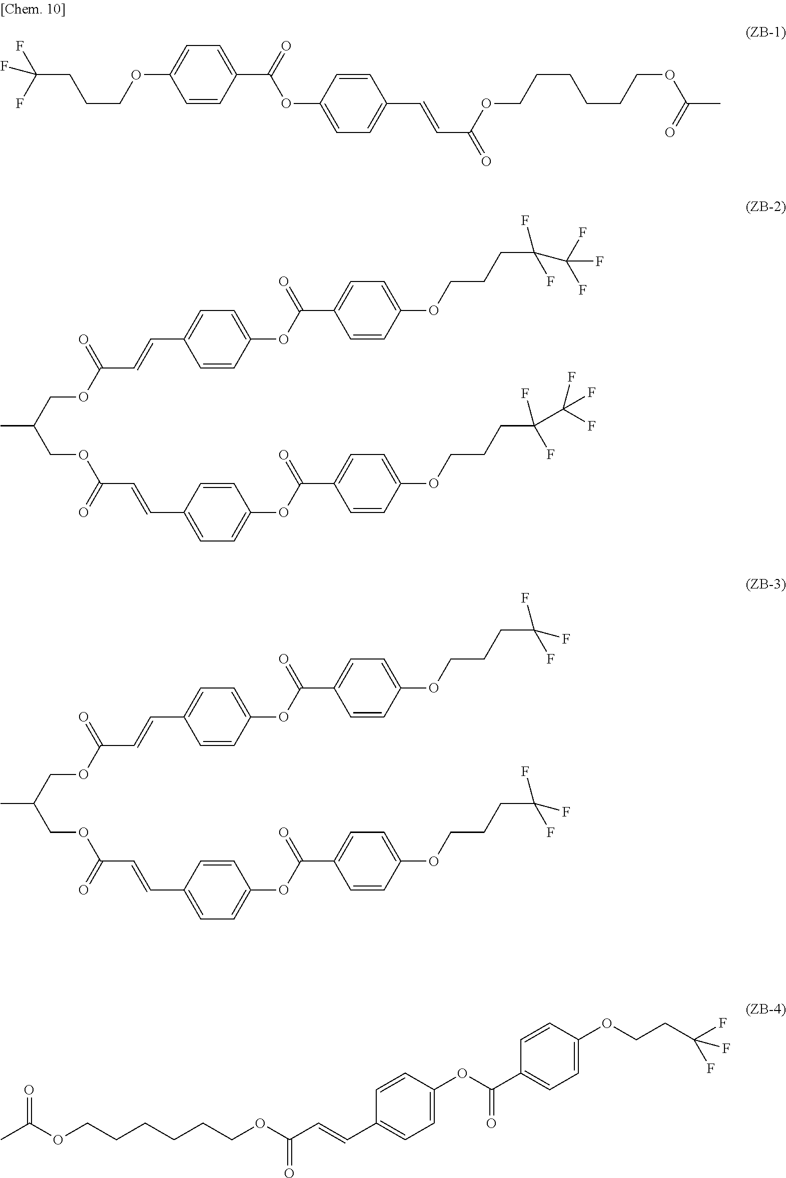

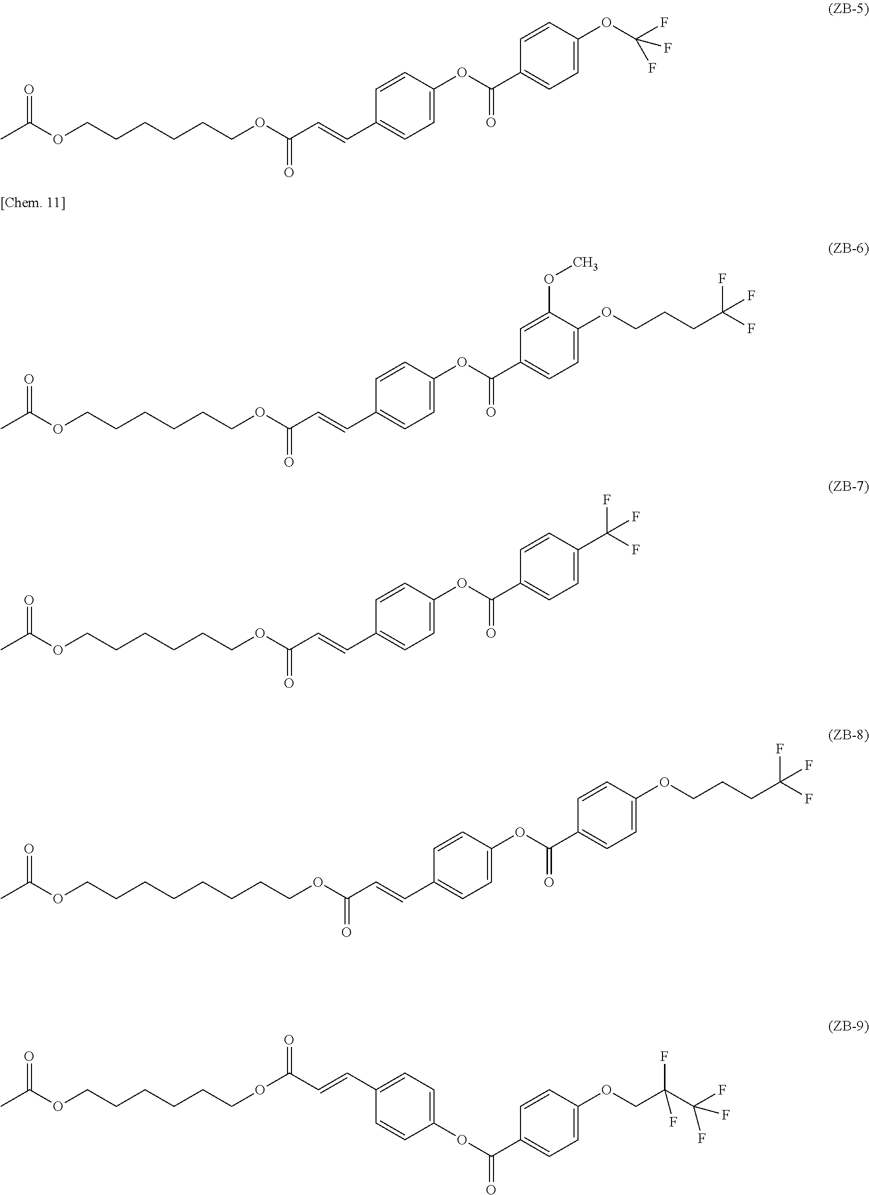 [SMILES: CC(=O)OCCCCCCOC(=O)/C=C/c1ccc(OC(=O)c2ccc(OC(F)(F)F)cc2)cc1 ; COc1cc(C(=O)Oc2ccc(/C=C/C(=O)OCCCCCCOC(C)=O)cc2)ccc1OCCCC(F)(F)F ; CC(=O)OCCCCCCOC(=O)/C=C/c1ccc(OC(=O)c2ccc(C(F)(F)F)cc2)cc1 ; CC(=O)OCCCCCCCCOC(=O)/C=C/c1ccc(OC(=O)c2ccc(OCCCC(F)(F)F)cc2)cc1 ; CC(=O)OCCCCCCOC(=O)/C=C/c1ccc(OC(=O)c2ccc(OCC(F)(F)C(F)(F)F)cc2)cc1]

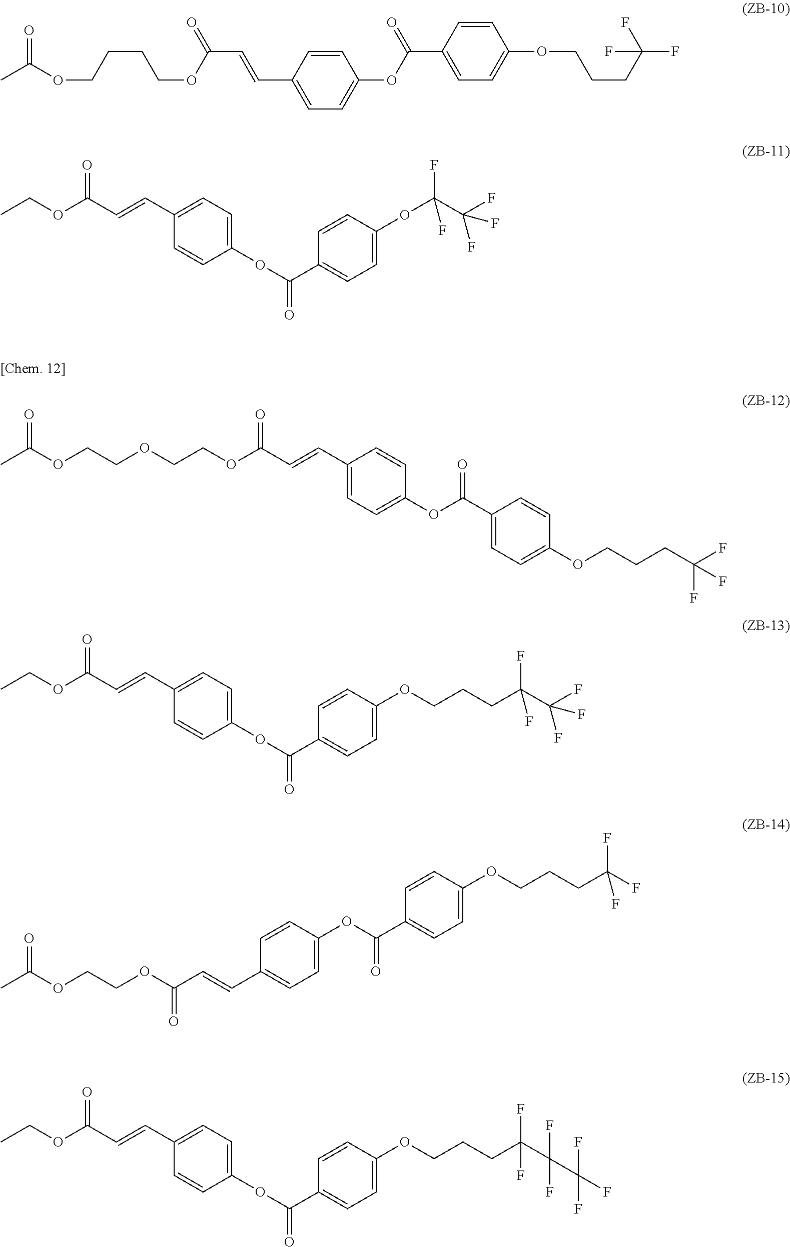 [SMILES: CC(=O)OCCCCOC(=O)/C=C/c1ccc(OC(=O)c2ccc(OCCCC(F)(F)F)cc2)cc1 ; CCOC(=O)/C=C/c1ccc(OC(=O)c2ccc(OC(F)(F)C(F)(F)F)cc2)cc1 ; CC(=O)OCCOCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)C(F)(F)F)cc2)cc1 ; CC(=O)OCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)C(F)(F)C(F)(F)F)cc2)cc1]

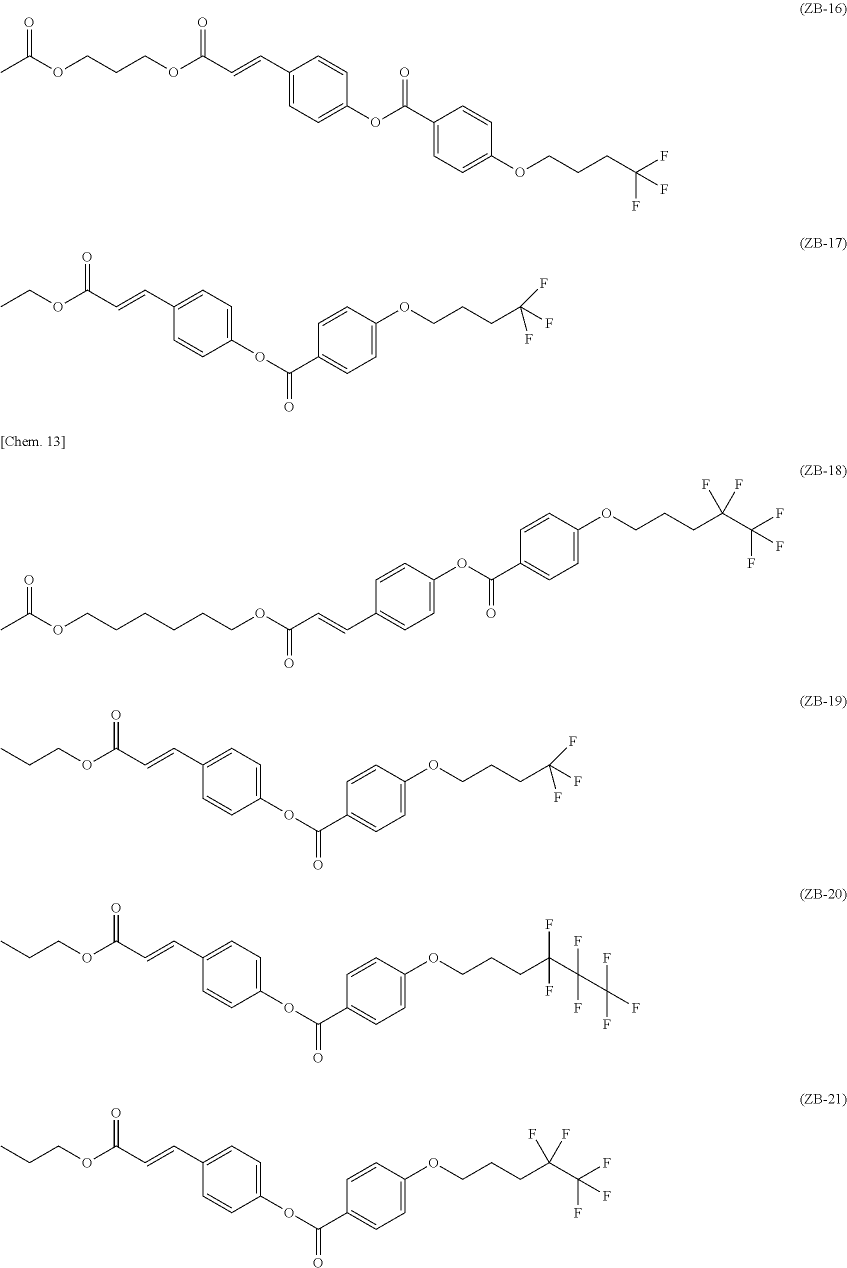 [SMILES: CC(=O)OCCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)F)cc2)cc1 ; CC(=O)OCCCCCCOC(=O)/C=C/c1ccc(OC(=O)c2ccc(OCCCC(F)(F)C(F)(F)F)cc2)cc1 ; CCCOC(=O)/C=C/c1ccc(OC(=O)c2ccc(OCCCC(F)(F)F)cc2)cc1 ; CCCOC(=O)/C=C/c1ccc(OC(=O)c2ccc(OCCCC(F)(F)C(F)(F)C(F)(F)F)cc2)cc1 ; CCCOC(=O)/C=C/c1ccc(OC(=O)c2ccc(OCCCC(F)(F)C(F)(F)F)cc2)cc1]

The thickness of the vertical alignment films 11 may be appropriately set without particular limitation, and is preferably 20 nm or more and 500 nm or less, more preferably 50 nm or more and 200 nm or less. A vertical alignment film 11 with a film thickness of less than 20 nm may fail in uniformly coating the entire surface of the substrate. A vertical alignment film 11 with a film thickness of more than 500 nm tends to cause irregularities on the surface of the alignment film, possibly causing display unevenness due to unexpected variation in tilt angles of the liquid crystal compound.

The vertical alignment polymer contained in the vertical alignment films 11 has a weight average molecular weight of preferably 10,000 to 1,000,000, more preferably 30,000 to 200,000. An alignment film polymer with a weight average molecular weight falling within the above range tends to achieve uniform coating with a desired film thickness. An alignment film polymer with too small a weight average molecular weight is less likely to achieve coating with a desired film thickness. A coating with too large a film thickness may fail to achieve a uniform thickness and may cause remarkable irregularities on the surface of the alignment film. The weight average molecular weight in the present invention may be measured by gel permeation chromatography (GPC).

The main chain of the vertical alignment polymer preferably contains a polyamic acid, a polyimide, a polysiloxane, or polyvinyl.

When the vertical alignment polymer includes a main chain that contains a polyamic acid structure, the polyamic acid structure is preferably represented by the following formula (P-1). When the vertical alignment polymer includes a main chain that contains a polyimide structure, the polyimide structure is preferably represented by the following formula (P-2).

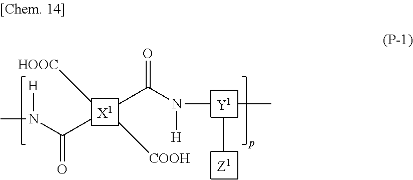

In the formula, X¹ is a tetravalent group, Y¹ is a trivalent group, Z¹ is a monovalent group containing a saturated aliphatic functional group at a terminal, and p is an integer of 1 or greater.

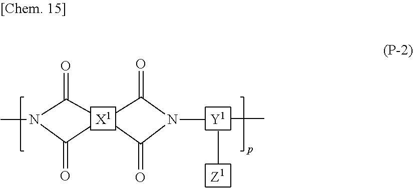

In the formula, X¹ is a tetravalent group, Y¹ is a trivalent group, Z¹ is a monovalent group containing a saturated aliphatic functional group at a terminal, and p is an integer of 1 or greater.

In the formulas (P-1) and (P-2), X¹ is a tetravalent group, preferably a C4-C20 cyclic-structure-containing group, more preferably a group that contains one to three C6 aromatic ring group(s) or one to three C4-C6 alicyclic group(s). When X¹ contains two or more aromatic ring groups or alicyclic groups, they may be bound to each other directly or via a linking group or may be condensed. Examples of the linking group include C1-C5 hydrocarbon groups, —O—, —N═N—, —C≡C—, —CH═CH—, and —CO—CH═CH—.

Specific examples of X¹ include chemical structures represented by the following formulas (X-1) to (X-16). At least one hydrogen atom included in each structure may be replaced by halogen, methyl, or ethyl group(s).

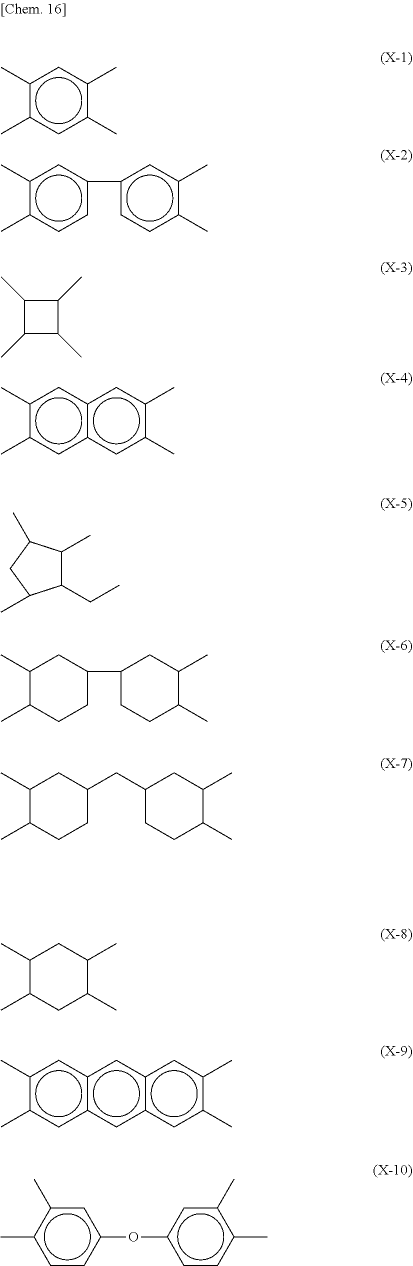

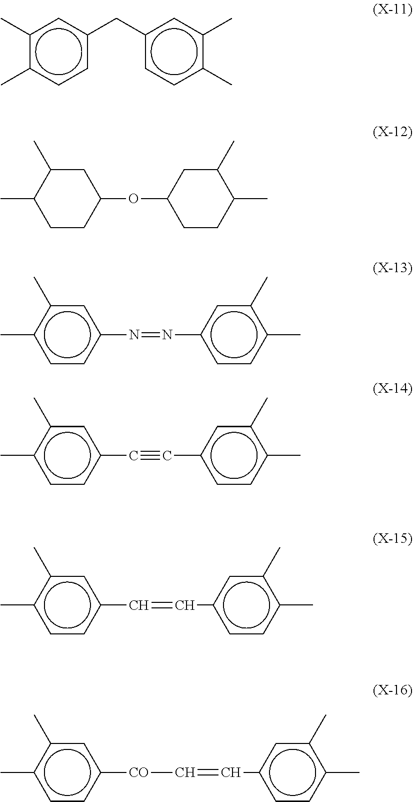

In the formulas (P-1) and (P-2), Y¹ is a trivalent group, preferably a C6-C20 aromatic ring-containing group, more preferably a group containing one to three C6 aromatic ring group(s). When Y¹ contains two or more aromatic ring groups, they may be bound to each other directly or via a linking group or may be condensed. Examples of the linking group include a C1-C5 hydrocarbon group, —O—, —N═N—, —C═C—, —CH═CH—, and —CO—CH═CH—.

Specific examples of Y¹ include chemical structures represented by the following formulas (Y-1) to (Y-24). At least one hydrogen atom contained in each structure may be replaced by halogen, methyl, or ethyl group(s).

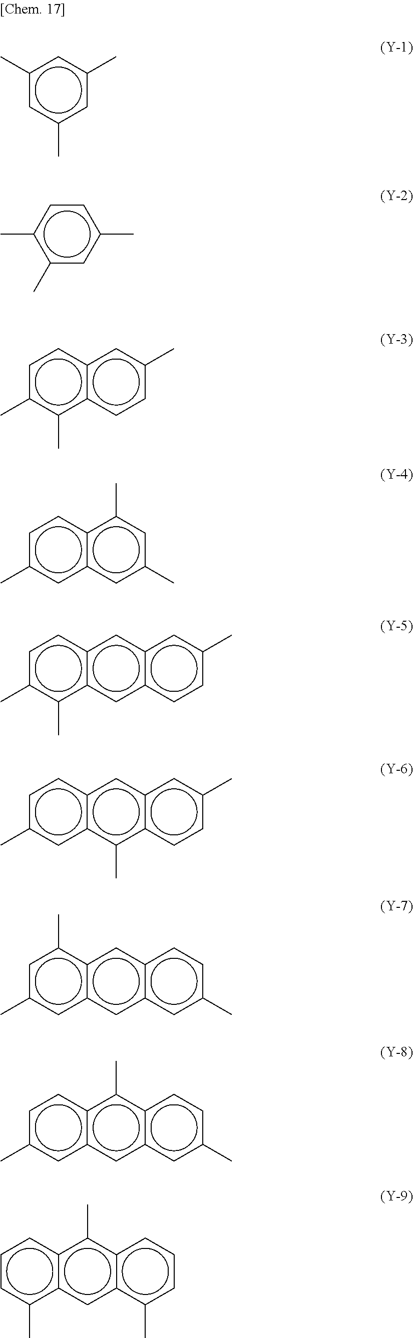

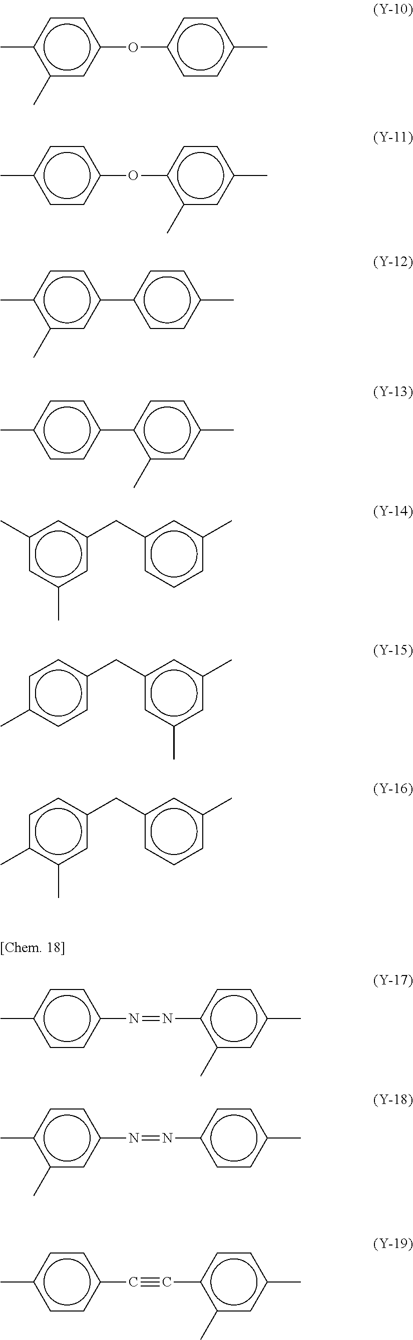

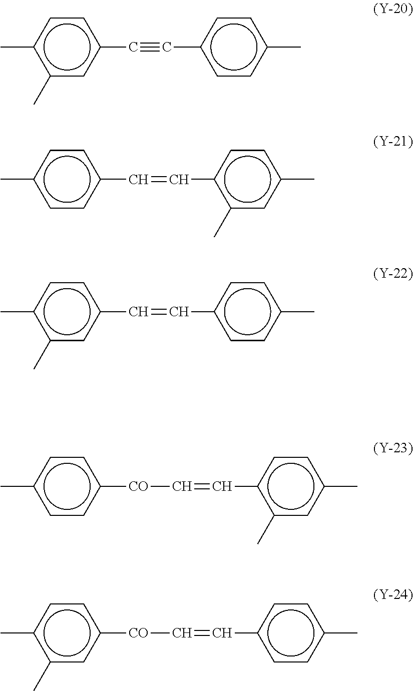

In the formulas (P-1) and (P-2), Z¹ is a monovalent group containing a saturated aliphatic functional group at a terminal. Z¹ is preferably a group represented by —(R^{Z})_{d}—(COO—Z)ₑ or —(R^{Z})_{d}—(OCO—Z)ₑ. In the formulas, R^{Z} is a C1-C5 group with a valence of e+1, d is 0 or 1, e is 1 or 2, Z has a cyclic structure and is a C15-C30 group containing a saturated aliphatic functional group at a terminal.

Specific examples of the group represented by —(R^{Z})_{d}—(COO—Z)ₑ or —(R^{Z})_{d}—(OCO—Z)ₑ include the chemical structures represented by the formulas (ZA-1) to (ZA-8) and (ZB-1) to (ZB-21).

The vertical alignment polymer containing at least one selected from the structures represented by the formulas (P-1) and (P-2) has a weight average molecular weight of preferably 10,000 to 1,000,000, more preferably 30,000 to 200,000. An alignment film polymer with a weight average molecular weight falling within the above range tends to achieve uniform coating with a desired film thickness. An alignment film polymer with too small a weight average molecular weight is less likely to achieve coating with a desired film thickness. A coating with too large a film thickness may fail to achieve a uniform thickness to cause remarkable irregularities on the surface of the film.

In one molecule of the vertical alignment polymer with the structure represented by the formula (P-1) or (P-2), X¹, Y¹, and Z¹ may each include one kind or two or more kinds thereof.

When the main chain of the vertical alignment polymer has a polysiloxane structure, the polysiloxane structure includes preferably a structure represented by the formula (P-3), more preferably a structure represented by the formula (P-4) or (P-5).

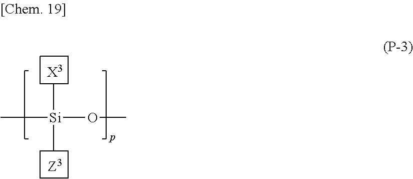

In the formula, X³ is a hydrogen atom, a hydroxy group, or a C1-C5 alkoxy group, Z³ is a monovalent group containing a saturated aliphatic functional group at a terminal, and p is an integer of 1 or greater.

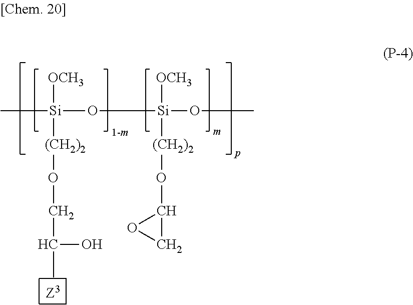

In the formula, Z³ is a monovalent group containing a saturated aliphatic functional group at a terminal, p is an integer of 1 or greater, and m is a real number of 0<m<1.

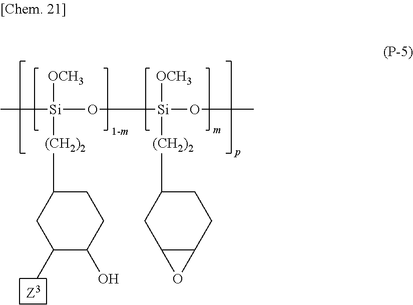

In the formula, Z³ is a monovalent group containing a saturated aliphatic functional group at a terminal, p is an integer of 1 or greater, and m is a real number of 0<m<1.

In the formula (P-3), X³ is a hydrogen atom, a hydroxy group, or a C1-C5 alkoxy group. Examples of the C1-C5 alkoxy group include —OCH₃, —OC₂H₅, —OC₃H₇, —OC₄H₉, and —OC₅H₁₁, and these may have a linear or branched structure. In the formula (P-3), X³ is preferably a hydrogen atom or a hydroxy, methoxy, or ethoxy group.

In the formulas (P-3) to (P-5), Z³ is a monovalent group containing a saturated aliphatic functional group at a terminal. Examples and preferred ranges of Z³ are the same as those of Z¹ in the formulas (P-1) and (P-2).

Specific examples of Z³ include, in addition to the chemical structures represented by the formulas (ZA-1) to (ZA-8) and (ZB-1) to (ZB-21), chemical structures represented by the formulas (ZC-1) and (ZC-2).

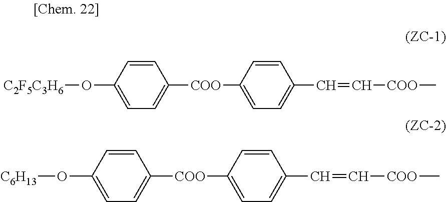

The vertical alignment polymer containing at least one selected from the structures represented by the formulas (P-3) to (P-5) has a weight average molecular weight of preferably 10,000 to 1,000,000, more preferably 30,000 to 200,000. An alignment film polymer with a weight average molecular weight falling within the above range tends to achieve uniform coating with a desired film thickness. An alignment film polymer with too small a weight average molecular weight is less likely to achieve coating with a desired film thickness. A coating with too large a film thickness may fail to achieve a uniform thickness to cause remarkable irregularities on the surface of the film.

In the formulas (P-4) and (P-5), m is a real number of 0<m<1, preferably 0.05<m<0.7, more preferably 0.2<m<0.5.

In one molecule of the vertical alignment polymer with the structure represented by the formula (P-3), X³ and Z³ may each include one kind or two or more kinds thereof. In one molecule of the vertical alignment polymer with the structure represented by the formula (P-4) or (P-5), Z³ may include one kind or two or more kinds thereof.

In the vertical alignment polymer with the structure represented by the formula (P-3), (P-4), or (P-5), the side chain terminal Z³ may include one kind or two or more kinds thereof.

When the main chain of the vertical alignment polymer includes a polyvinyl structure, the polyvinyl structure preferably includes a structure represented by the formula (P-6).

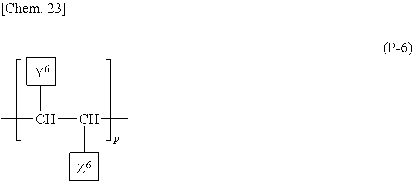

In the formula, Y⁶ is a hydrogen atom or a C1-C5 alkyl group, Z⁶ is a monovalent group containing a saturated aliphatic functional group at a terminal, and p is an integer of 1 or greater.

In the formula (P-6), Y⁶ is a hydrogen atom or a C1-C5 alkyl group. Examples of the C1-C5 alkyl group include —CH₃, —C₂H₅, —C₃H₇, —C₄H₉, and —C₅H₁₁ and these may have a linear or branched structure. In the formula (P-6), Y⁶ is preferably a hydrogen atom or a methyl or ethyl group.

In the formula (P-6), Z⁶ is a monovalent group containing a saturated aliphatic functional group at a terminal. Examples and preferred ranges of Z⁶ are the same as those of Z¹ in the formulas (P-1) and (P-2).

Specific examples of Z⁶ include chemical structures represented by the formulas (ZA-1) to (ZA-8), (ZB-1) to (ZB-21), (ZC-1), and (ZC-2).

The vertical alignment polymer containing the structure represented by the formula (P-6) has a weight average molecular weight of preferably 10,000 to 1,000,000, more preferably 30,000 to 200,000. An alignment film polymer with a weight average molecular weight falling within the above range tends to achieve uniform coating with a desired film thickness. An alignment film polymer with too small a weight average molecular weight is less likely to achieve coating with a desired film thickness. A coating with too large a film thickness may fail to achieve a uniform thickness to cause remarkable irregularities on the surface of the film.

In one molecule of the vertical alignment polymer with the structure represented by the formula (P-6), Y⁶ and Z⁶ may each include one kind or two or more kinds thereof.

Preferably, the vertical alignment films contain at least one of the vertical alignment polymers represented by the formulas (P-1) to (P-6) and may include two or more kinds of the vertical alignment polymers. More preferably, the vertical alignment films contain the vertical alignment polymer represented by the formula (P-1) or (P-2). Still more preferably, X¹ in the formula (P-1) or (P-2) is a structure represented by any of the formulas (X-1) to (X-16), Y¹ is a structure represented by any of the formulas (Y-1) to (Y-24), Z¹ is a structure represented by any of the formulas (ZA-1) to (ZA-8) and (ZB-1) to (ZB-21).

The liquid crystal panel 1 may be driven by passive driving or active driving. In passive driving, stripe-patterned electrodes are arranged on upper and lower substrates in a crossed manner and voltage is selectively applied to the intersections of the electrodes. In active driving, an active element such as a transistor is provided in each pixel and on or off of the active element is controlled to enable writing of driving voltage to the pixel portion. The pixel portion holds the voltage by storage capacitance even after the active element is turned off.

The liquid crystal panel 1 is preferably driven by passive driving. A passive driving liquid crystal panel 1 can suppress a decrease in voltage holding ratio (VHR) caused by radicals and ions generated by use of the tolan liquid crystal compound.

Examples of the liquid crystal alignment mode of the liquid crystal panel 1 include a vertical alignment-electrically controlled birefringence (VA-ECB) mode.

The VA-ECB mode is a liquid crystal alignment mode using the birefringence of liquid crystal molecules (hereinafter, also referred to as a birefringence mode). In the birefringence mode, changing the voltage applied to liquid crystal molecules changes the retardation. In a birefringence mode liquid crystal panel, the polarization state of linearly polarized light emerging from the back surface side polarizing plate is altered by the birefringence of the liquid crystal panel to be converted into elliptically polarized light whose ellipticity usually corresponds to the degree of the imparted retardation. The amount of the elliptically polarized light passing through the front surface side polarizing plate thus varies according to the ellipticity (i.e., applied voltage).

In a VA-ECB-mode liquid crystal panel with no voltage applied, liquid crystal molecules are aligned vertically to each substrate surface, causing zero retardation. In the VA-ECB-mode liquid crystal panel with no voltage applied, when the transmission axis of the back surface side polarizing plate and the transmission axis of the front surface side polarizing plate are placed parallel to each other, linearly polarized light vibrating in the direction parallel to the both transmission axes passes through the polarizing plates while holding its polarization state. Thus, the transmitted light is achromatic in the VA-ECB-mode liquid crystal panel with no voltage applied.

Meanwhile, application of voltage gradually tilts the liquid crystal molecules in the direction parallel to each substrate surface, thereby gradually increasing the retardation. Δε a result, the transmittance of the liquid crystal panel gradually decreases. For example, the transmittance of light having a wavelength of 550 nm becomes minimum when the retardation is 275 nm. The transmittance of light here is proportional to the formula [cos(π×R/λ)]² wherein R is the retardation of a medium in a configuration including two polarizing plates whose transmission axes are parallel to each other and the medium disposed between the plates, and λ is the wavelength of light incident on the configuration. For example, when the retardation R is half the wavelength λ, the minimum transmittance is obtained. It should be noted that light having a wavelength of 550 nm is light having a wavelength at which the human sensitivity, a luminosity factor, is highest.

The birefringence effects described above, i.e., the effects such as the effect of altering the polarization state of the incident polarized light and the effect of changing the transmittance thereof involve large wavelength dispersion. In a birefringence mode liquid crystal panel, the transmitted light therefore generally cannot be achromatic except for the state of zero retardation. In other words, the birefringence mode liquid crystal panel is capable of switching, in transmission of incident polarized light, between a non-coloring mode of not altering the polarization state of the polarized light (zero retardation state) and a coloring mode of altering the polarization state of the polarized light (non-zero retardation state). The non-coloring mode corresponds to, for example, the state with no voltage applied (the state where a voltage higher than the threshold value is not applied so as to prevent generation of birefringence) in a VA-ECB-mode liquid crystal panel. The coloring mode corresponds to, for example, the state with voltage applied (the state where a voltage higher than the threshold value is applied so as to cause birefringence) in a VA-ECB-mode liquid crystal panel.

### Embodiment 2

### <Switchable Mirror Panel>

The switchable mirror panel of Embodiment 2 is the same as the liquid crystal panel 1 of Embodiment 1 except that polarizing plates are disposed on the liquid crystal panel 1 of Embodiment 1. Thus, in the present embodiment, features unique to the present embodiment are mainly described and similar explanations to those in Embodiment 1 are appropriately omitted.

FIG. 2 is a schematic cross-sectional view of a switchable mirror panel of Embodiment 2. As shown in FIG. 2, a switchable mirror panel 2 of the present embodiment includes, in the following order from the back surface side to the front surface side, a reflective polarizing plate 40, the liquid crystal panel 1, and an absorptive polarizing plate 50. The reflective polarizing plate 40 may be bonded to the back surface side of the liquid crystal panel 1 via a pressure-sensitive adhesive or the like. The absorptive polarizing plate 50 may be bonded to the front surface side of the liquid crystal panel 1 via a pressure-sensitive adhesive or the like. The expression “back surface side” herein refers to, in FIG. 2, for example, the lower side of the switchable mirror panel 2 (reflective polarizing plate 40 side). The expression “front surface side” refers to, in FIG. 2, for example, the upper side of the switchable mirror panel 2 (absorptive polarizing plate 50 side). In the present embodiment, the switchable mirror panel 2 is viewed from the front surface side (absorptive polarizing plate 50 side).

The relationship between the transmission axis of the reflective polarizing plate 40 and the transmission axis of the absorptive polarizing plate 50 can be appropriately designed to suit the liquid crystal alignment mode of the liquid crystal panel 1. In order to improve the transparency (visibility of background) of the transparent mode and the specularity (visibility of mirror image) of the mirror mode, the transmission axis of the reflective polarizing plate 40 and the transmission axis of the absorptive polarizing plate 50 are preferably parallel to or perpendicular to each other. The phrase “two transmission axes are parallel to each other” herein means that the two axes make an angle in the range of 0±3°, preferably 0±1°, more preferably 0±0.5°, particularly preferably 0° (perfectly parallel to each other). The phrase “two transmission axes are perpendicular to each other” means that the two axes make an angle in the range of 90±3°, preferably 90±1°, more preferably 90±0.5°, particularly preferably 90° (perfectly perpendicular to each other).

The reflective polarizing plate 40 may be, for example, a multilayer reflective polarizing plate, a nano-wire grid polarizing plate, or a reflective polarizing plate that utilizes selective reflection of cholesteric liquid crystal. Examples of the multilayer reflective polarizing plate include a reflective polarizing plate (trade name: DBEF) available from Sumitomo 3M Ltd. Examples of the reflective polarizing plate that utilizes selective reflection of cholesteric liquid crystal include a reflective polarizing plate (trade name: PCF) available from Nitto Denko Corporation. The reflectance and transmittance of the reflective polarizing plate 2 are not particularly limited, and may be adjusted as desired by stacking two or more reflective polarizing plates on each other with their transmission axes shifted from each other. The term “reflectance” herein indicates the luminous reflectance unless otherwise stated.

The absorptive polarizing plate 50 may be, for example, a plate obtained by adsorption alignment of a dichroic anisotropic material, such as an iodine complex, on a polyvinyl alcohol (PVA) film. The absorptive polarizing plate has a function of absorbing incident polarized light vibrating in the direction parallel to its absorption axis and transmitting incident polarized light vibrating in the direction parallel to its transmission axis perpendicular to the absorption axis.

Since the role of the switchable mirror panel 2 is to switch between the transparent mode and the mirror mode, there is no need to provide a color filter layer on the first substrate 10 and second substrate 20.

The switchable mirror panel 2 is capable of switching between the transparent mode and the mirror mode by the following principle. In other words, the switchable mirror panel 2 can be used as a see-through display. Here, the transparent mode is a state in which voltage applied to the liquid crystal panel 1 controls the alignment of liquid crystal molecules in the liquid crystal layer 30 so that light incident on the reflective polarizing plate 40 from the back surface side passes through the absorptive polarizing plate 50. The mirror mode is a state in which voltage applied to the liquid crystal panel 1 controls the alignment of liquid crystal molecules in the liquid crystal layer 30 so that light incident on the absorptive polarizing plate 50 from the front surface side is reflected by the reflective polarizing plate 40. The following describes the case where the liquid crystal panel 1 is a VA-ECB-mode liquid crystal panel.

First, the case is described where the transmission axis of the reflective polarizing plate 40 and the transmission axis of the absorptive polarizing plate 50 are parallel to each other in the switchable mirror panel 2.

### (Transparent Mode)

The transparent mode is achieved when no voltage is applied to the liquid crystal panel 1. This will be specifically described below.

First, light incident on the reflective polarizing plate 40 from the back surface side that vibrates in the direction parallel to the transmission axis of the reflective polarizing plate 40 passes through the reflective polarizing plate 40 to be converted into linearly polarized light. Here, the liquid crystal panel 1 has zero retardation. The linearly polarized light emerging from the reflective polarizing plate 40 thus passes through the liquid crystal panel 1 (with no voltage applied) while holding its polarization state (non-coloring mode). The linearly polarized light emerging from the liquid crystal panel 1 passes through the absorptive polarizing plate 50 whose transmission axis is parallel to the transmission axis of the reflective polarizing plate 40.

Light incident on the reflective polarizing plate 40 from the back surface side that vibrates in the direction perpendicular to the transmission axis (parallel to the reflection axis) of the reflective polarizing plate 40 is reflected by the reflective polarizing plate 40 to the back surface side.

Thereby, the back surface side of the switchable mirror panel 2 is visible in the transparent mode. In addition, light incident on the absorptive polarizing plate 50 from the front surface side that vibrates in the direction parallel to the transmission axis of the absorptive polarizing plate 50 passes through the absorptive polarizing plate 50, the liquid crystal panel 1 (with no voltage applied), and the reflective polarizing plate 40. Light incident on the absorptive polarizing plate 50 from the front surface side that vibrates in the direction perpendicular to the transmission axis (in the direction parallel to the absorption axis) of the absorptive polarizing plate 50 is absorbed by the absorptive polarizing plate 50. This achieves no reflection of external light (light incident on the absorptive polarizing plate 50 from the front surface side) by the reflective polarizing plate 40, preventing low visibility of the back surface side of the switchable mirror panel 2.

### (Mirror Mode)

The mirror mode is achieved when voltage is applied to the liquid crystal panel 1. This will be specifically described below.

First, light incident on the absorptive polarizing plate 50 from the front surface side that vibrates in the direction parallel to the transmission axis of the absorptive polarizing plate 50 passes through the absorptive polarizing plate 50 to be converted into linearly polarized light. The polarization state of linearly polarized light emerging from the absorptive polarizing plate 50 is altered by the birefringence effects of the liquid crystal panel 1 (coloring mode) as it passes through the liquid crystal panel 1 (with voltage applied), and the linearly polarized light is converted into elliptically polarized light. The elliptically polarized light emerging from the liquid crystal panel 1 that vibrates in the direction parallel to the transmission axis of the reflective polarizing plate 40 passes through the reflective polarizing plate 40. In contrast, the elliptically polarized light emerging from the liquid crystal panel 1 that vibrates in the direction perpendicular to the transmission axis (parallel to the reflection axis) of the reflective polarizing plate 40 is reflected by the reflective polarizing plate 40 as linearly polarized light. The polarization state of the linearly polarized light reflected by the reflective polarizing plate 40 is altered by the birefringence effects of the liquid crystal panel 1 as it passes through the liquid crystal panel 1, and the linearly polarized light is converted into elliptically polarized light. The elliptically polarized light emerging from the liquid crystal panel 1 that vibrates in the direction parallel to the transmission axis of the absorptive polarizing plate 50 passes through the absorptive polarizing plate 50 to be emitted as reflected light to the front surface side. The elliptically polarized light emerging from the liquid crystal panel 1 that vibrates in the direction perpendicular to the transmission axis (parallel to the absorption axis) of the absorptive polarizing plate 50 is absorbed by the absorptive polarizing plate 50.

Light incident on the absorptive polarizing plate 50 from the front surface side that vibrates in the direction perpendicular to the transmission axis (parallel to the absorption axis) of the absorptive polarizing plate 50 is absorbed by the absorptive polarizing plate 50.

Thereby, a mirror image is visible by reflected light in the mirror mode. In addition, the liquid crystal panel 1 includes segment electrodes. Voltage application to part(s) of the pixels thus enables display of information such as letters and images by reflected light. Here, variation in polarization state caused by the birefringence and variations in transmittance and reflectance that accompany the polarization state variation involve large wavelength dispersion. The intensity of reflected light thus varies according to the wavelength. Namely, the reflected light is colored in the mirror mode. In the pixels with no voltage applied, the back surface side of the switchable mirror panel 2 is visible.

In a liquid crystal panel 1 of birefringence mode (e.g., VA-ECB-mode), the color of reflected light can be adjusted by the effective retardation introduced by the liquid crystal panel 1. The “effective retardation” (also referred to simply as retardation) herein refers to the retardation observed from the normal direction in the state where a certain level of voltage is applied to a birefringence mode liquid crystal panel. For example, in a VA-ECB-mode liquid crystal panel, the effective retardation is zero because the liquid crystal molecules are aligned perpendicularly to each substrate surface when no voltage is applied. Here, application of voltage gradually tilts the liquid crystal molecules in the direction parallel to each substrate surface, thereby gradually increasing the effective retardation. When all the liquid crystal molecules are uniformly tilted in the direction parallel to each substrate surface, the effective retardation becomes maximum. Here, the maximum effective retardation in principle is represented by Δnd (hereinafter, also referred to as liquid crystal retardation) where Δn is the refractive index anisotropy of the liquid crystal (liquid crystal layer 30) constituting the liquid crystal panel 1 and d is the thickness of the liquid crystal layer.

With the actual configuration and materials of the liquid crystal panel 1, it is difficult to align all the liquid crystal molecules uniformly. Typically, the liquid crystal molecules are not uniformly distributed in at least one of the thickness direction and the horizontal direction of the liquid crystal layer 30. For example, liquid crystal molecules in the vicinity of each substrate surface are less likely to move even when voltage is applied due to the alignment regulating force of the alignment films. In contrast, liquid crystal molecules in the vicinity of the center portion in the thickness direction are more likely to move when voltage is applied. Liquid crystal molecules are therefore not uniformly aligned in the thickness direction. For these reasons, the maximum effective retardation is actually not completely the same as, but is slightly lower than, the liquid crystal retardation (Δnd). It is still true that a larger liquid crystal retardation leads to a larger maximum effective retardation and thus widens the range of the retardation that can be achieved by the birefringence mode liquid crystal panel 1. Hence, setting the value of the liquid crystal retardation of the birefringence mode liquid crystal panel 1 is important for color adjustment of reflected light. A larger liquid crystal retardation is more preferred.

As described above, the transmittance of the birefringence mode liquid crystal panel 1 in principle is minimum when the effective retardation is half the wavelength of incident light. That is, increasing the effective retardation to a value greater than the half of the wavelength of incident light corresponds to sufficiently shifting the alignment state of the liquid crystal molecules. For example, in a VA-ECB-mode liquid crystal panel, it corresponds to shifting the alignment of the liquid crystal molecules perpendicular to each substrate surface to the alignment parallel to each substrate surface. This means that, in the coloring mode, the color of reflected light can be adjusted when the birefringence mode liquid crystal panel 1 introduces a retardation (effective value) greater than the half of the wavelength of incident light. Such a retardation of the birefringence mode liquid crystal panel 1 is usually designed for light having a wavelength of 550 nm at which the human sensitivity, a luminosity factor, is highest. Hence, in the coloring mode, the birefringence mode liquid crystal panel 1 is preferably capable of changing the retardation to a value greater than 275 nm when measured with light having a wavelength of 550 nm. This enables adjustment of the color of reflected light.

In the following, the case is described where the transmission axis of the reflective polarizing plate 40 and the transmission axis of the absorptive polarizing plate 50 are perpendicular to each other in the switching mirror panel 2.

### (Transparent Mode)

The transparent mode is achieved when voltage is applied to the liquid crystal panel 1. This will be specifically described below.

First, light incident on the reflective polarizing plate 40 from the back surface side that vibrates in the direction parallel to the transmission axis of the reflective polarizing plate 40 passes through the reflective polarizing plate 40 to be converted into linearly polarized light. The polarization state of the linearly polarized light emerging from the reflective polarizing plate 40 is altered by the birefringence effects of the liquid crystal panel 1 (coloring mode) as it passes through the liquid crystal panel 1 (with voltage applied), and the linearly polarized light is converted into elliptically polarized light. The elliptically polarized light emerging from the liquid crystal panel 1 that vibrates in the direction parallel to the transmission axis of the absorptive polarizing plate 50 passes through the absorptive polarizing plate 50. In contrast, the elliptically polarized light emerging from the liquid crystal panel 1 that vibrates in the direction perpendicular to the transmission axis (parallel to the absorption axis) of the absorptive polarizing plate 50 is absorbed by the absorptive polarizing plate 50.

Light incident on the reflective polarizing plate 40 from the back surface side that vibrates in the direction perpendicular to the transmission axis (parallel to the reflection axis) of the reflective polarizing plate 40 is reflected by the reflective polarizing plate 40 to the back surface side.

Thereby, the back surface side of the switchable mirror panel 2 is visible in the transparent mode. Here, variation in polarization state caused by the birefringence and variation in transmittance that accompanies the polarization state variation involve large wavelength dispersion. Transmitted light passing through the switchable mirror panel 2 from the back surface side thus changes its intensity according to the wavelength. Namely, transmitted light is colored in the transparent mode.

### (Mirror Mode)

The mirror mode is achieved when no voltage is applied to the liquid crystal panel 1. This will be specifically described below.

First, light incident on the absorptive polarizing plate 50 from the front surface side that vibrates in the direction parallel to the transmission axis of the absorptive polarizing plate 50 passes through the absorptive polarizing plate 50 to be converted into linearly polarized light. Here, the liquid crystal panel 1 has zero retardation. The linearly polarized light emerging from the absorptive polarizing plate 50 thus passes through the liquid crystal panel 1 (with no voltage applied) while holding its polarization state (non-coloring mode). The linearly polarized light emerging from the liquid crystal panel 1 is reflected by the reflective polarizing plate 40 whose reflection axis is parallel to the transmission axis of the absorptive polarizing plate 50. The linearly polarized light reflected by the reflective polarizing plate 40 passes through the liquid crystal panel 1 and then the absorptive polarizing plate 50 to be emitted as reflected light to the front surface side.

Light incident on the absorptive polarizing plate 50 from the front surface side that vibrates in the direction perpendicular to the transmission axis (parallel to the absorption axis) of the absorptive polarizing plate 50 is absorbed by the absorptive polarizing plate 50.

Thereby, a mirror image is visible by reflected light in the mirror mode. In addition, the liquid crystal panel 1 includes segment electrodes. No voltage application to part(s) of the pixels enables display of information such as letters and images by reflected light. Here, reflected light is colorless (achromatic). In the pixels with voltage applied, the back surface side of the switchable mirror panel 2 is visible.

When the liquid crystal panel 1 is a birefringence mode (e.g., VA-ECB-mode) liquid crystal panel, the transmission axis of the reflective polarizing plate 40 and the transmission axis of the absorptive polarizing plate 50 are preferably parallel to each other from the viewpoint of improving the transmittance of the switchable mirror panel 2 in the transparent mode. If the transmission axis of the reflective polarizing plate 40 and the transmission axis of the absorptive polarizing plate 50 are perpendicular to each other, the transparent mode is achieved when voltage is applied to the liquid crystal panel 1 as stated above, which causes retardation.

### Embodiment 3

### <Switchable Mirror Display>

A switchable mirror display of Embodiment 3 is the same as the switchable mirror panel 2 of Embodiment 2 except that a display device is provided for the switchable mirror panel 2 of Embodiment 2. Thus, in the present embodiment, features unique to the present embodiment are mainly described and similar explanations to those in Embodiment 2 are appropriately omitted.

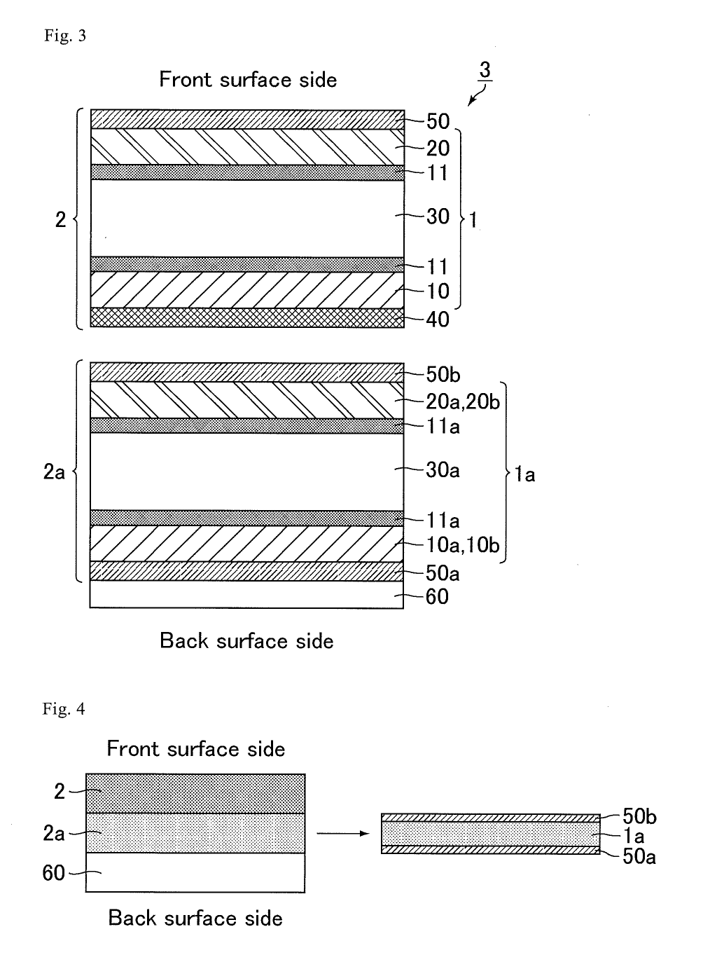

FIG. 3 is a schematic cross-sectional view of a switchable mirror display of Embodiment 3. The switchable mirror display 3 of Embodiment 3 includes, in the following order from the back surface side to the front surface side, a backlight 60, a liquid crystal display part 2a, and the switchable mirror panel 2.

The present embodiment gives a configuration in which the switchable mirror panel 2 and the liquid crystal display part 2a are disposed with a distance (with an air layer in between). These members may be bonded together with a pressure-sensitive adhesive or the like.

The liquid crystal display part 2a includes, in the following order from the back surface side to the front surface side, an absorptive polarizing plate 50a, a liquid crystal panel 1a for display, and an absorptive polarizing plate 50b. The absorptive polarizing plate 50a may be bonded to the back surface side of the liquid crystal panel 1a for display with a pressure-sensitive adhesive or the like. The absorptive polarizing plate 50b may be bonded to the front surface side of the liquid crystal panel 1a for display with a pressure-sensitive adhesive or the like. In the present embodiment, the switchable mirror display 3 is viewed from the front surface side (the absorptive polarizing plate 50b side). Namely, the switchable mirror display 3 has a display surface on the switchable mirror panel 2 side.

The relationship between the transmission axis of the absorptive polarizing plate 50a and the transmission axis of the absorptive polarizing plate 50b can be appropriately designed to suit the liquid crystal alignment mode of the liquid crystal panel 1a for display. The absorptive polarizing plate 50b may be excluded and the functions thereof may alternatively be conducted by the reflective polarizing plate 40. Yet, since the degree of polarization of a reflective polarizing plate is typically lower than that of an absorptive polarizing plate, exclusion of the absorptive polarizing plate 50b causes a decrease in the contrast ratio in the display mode. Conversely, a sufficient degree of polarization of the reflective polarizing plate 40 allows exclusion of the absorptive polarizing plate 50b. In order to exclude the absorptive polarizing plate 50b, the degree of polarization of the reflective polarizing plate 40 is preferably 90% or higher (contrast ratio of 10 or higher), more preferably 99% or higher (contrast ratio of 100 or higher).

The absorptive polarizing plate 50a and the absorptive polarizing plate 50b may each be, for example, a plate obtained by adsorption alignment of a dichroic anisotropic material, such as an iodine complex, on a polyvinyl alcohol film.

The backlight 60 may be of any type such as an edge-lit backlight or a direct-lit backlight. The light source of the backlight 60 may be of any type such as light emitting diodes (LEDs) or cold cathode fluorescent lamps (CCFLs).

The liquid crystal panel 1a for display has a configuration including a liquid crystal layer 30a held between paired substrates 10a and 20a and alignment films 11a disposed between the substrate 10a and the liquid crystal layer 30a and between the substrate 20a and the liquid crystal layer. The paired substrates 10a and 20a constituting the liquid crystal panel 1a for display are attached to each other with a sealant to hold the liquid crystal layer 30a in between.

The paired substrates 10a and 20a constituting the liquid crystal panel 1a for display may be of any type such as an active substrate 10b and a color filter substrate 20b in combination.

The active substrate 10b may have a configuration including, for example, various conductive lines such as thin-film transistor elements on a transparent substrate such as a glass substrate or a plastic substrate. The thin-film transistor elements each include a semiconductor layer which may contain, without limitation, amorphous silicon, low-temperature polysilicon, or oxide semiconductor. Examples of the oxide semiconductor include compounds containing indium, gallium, zinc, and oxygen and compounds containing indium, zinc, and oxygen. In the case of using as the oxide semiconductor a compound containing indium, gallium, zinc, and oxygen which has a low off-leakage current, application of voltage to the oxide semiconductor enables paused drive in which the voltage is held until the next data signal (voltage) is input (applied). A compound containing indium, gallium, zinc, and oxygen is therefore preferred as the oxide semiconductor in terms of low power consumption.

The color filter substrate 20b may have a configuration including, for example, a color filter layer disposed on a transparent substrate such as a glass substrate or a plastic substrate. The combination of colors for the color filter layer may be, but is not particularly limited to, a combination of red, green, and blue, or a combination of red, green, blue, and yellow.

The liquid crystal alignment mode of the liquid crystal panel 1a for display may be, but is not particularly limited to, a multi-domain vertical alignment (MVA) mode, a fringe field switching (FFS) mode, a vertical alignment (VA) mode, an in-plane switching (IPS) mode, an optically compensated birefringence (OCB) mode, and a TN mode. Among these, the FFS mode is preferred.

In a MVA-mode liquid crystal panel with no voltage applied, liquid crystal molecules having a negative anisotropy of dielectric constant are aligned perpendicularly to each substrate surface. The MVA-mode liquid crystal panel includes structures such as ribs or slits disposed on at least one of the substrates. These structures control liquid crystal molecules to tilt in directions when voltage is applied to achieve a wide viewing angle. The MVA mode encompasses an ultra-violet induced multi-domain vertical alignment (UV²A) mode that uses alignment division of a photo-alignment film.

In a FFS-mode liquid crystal panel, alignment films disposed on paired substrates are subjected to rubbing treatment in the direction anti-parallel to each other. Thus, when no voltage is applied, liquid crystal molecules are aligned parallelly to each substrate surface. Here, one of the paired substrates constituting the FFS-mode liquid crystal panel includes, in the following order from the liquid crystal layer side, an upper layer electrode (comb-teeth electrode) with slits, a transparent insulating film (e.g., nitride film), and a planar (solid) lower layer electrode. In this configuration, voltage application between the upper and lower layer electrodes generates fringe electric fields. The FFS-mode liquid crystal panel thus enables the fringe electric fields to vary the alignment direction of liquid crystal molecules, thereby controlling the amount of transmitted light.

The present embodiment gives a configuration in which the liquid crystal display part 2a is disposed on the back surface side of the switchable mirror panel 2. The liquid crystal display part 2a may be replaced by a different display device including a polarizing plate. Examples of the different display device include display devices that emit polarized light, such as an organic electroluminescence display device including an absorptive circularly polarizing plate for antireflection and a micro electro mechanical system (MEMS) display to which a polarizing plate is attached.

The switchable mirror display 3 can be operated by the following principle. Described here is the case where the liquid crystal panel 1 is a VA-ECB-mode liquid crystal panel and the liquid crystal panel 1a for display is a MVA-mode or FFS-mode liquid crystal panel.

In the following, the case is described where the transmission axis of the reflective polarizing plate 40 and the transmission axis of the absorptive polarizing plate 50 are parallel to each other in the switchable mirror panel 2. In the liquid crystal display part 2a, the transmission axis of the absorptive polarizing plate 50a and the transmission axis of the absorptive polarizing plate 50b are perpendicular to each other. The transmission axis of the reflective polarizing plate 40 and the transmission axis of the absorptive polarizing plate 50b are parallel to each other.

### (Transparent Mode)

The transparent mode is achieved when no voltage is applied to the liquid crystal panel 1. This will be specifically described below.

When the liquid crystal panel 1a for display provides an image (display mode), linearly polarized light emitted from the liquid crystal display part 2a (linearly polarized light emerging from the absorptive polarizing plate 50b) passes through the reflective polarizing plate 40 whose transmission axis is parallel to the transmission axis of the absorptive polarizing plate 50b. Here, the liquid crystal panel 1 has zero retardation. The linearly polarized light emerging from the reflective polarizing plate 40 passes through the liquid crystal panel 1 (with no voltage applied) while holding its polarization state (non-coloring mode). The linearly polarized light emerging from the liquid crystal panel 1 passes through the absorptive polarizing plate 50 whose transmission axis is parallel to the transmission axis of the reflective polarizing plate 40. In other words, despite the existence of the switchable mirror panel 2, the image provided by the liquid crystal panel 1a for display is visible as in the case without the switchable mirror panel 2.

Meanwhile, light incident on the absorptive polarizing plate 50 from the front surface side that vibrates in the direction parallel to the transmission axis of the absorptive polarizing plate 50 passes through the absorptive polarizing plate 50 to be converted into linearly polarized light. The linearly polarized light emerging from the absorptive polarizing plate 50 passes through the liquid crystal panel 1 while holding its polarization state. The linearly polarized light emerging from the liquid crystal panel 1 passes through the reflective polarizing plate 40 whose transmission axis is parallel to the transmission axis of the absorptive polarizing plate 50. The linearly polarized light emerging from the reflective polarizing plate 40 passes through the absorptive polarizing plate 50b and is absorbed by the absorptive polarizing plate 50a or members of the liquid crystal panel 1a for display, such as a color filter layer and black matrix. There is thus little light that travels back as reflected light to the front surface side of the switchable mirror display 3.

Thereby, the image provided by the liquid crystal panel 1a for display is visible in the transparent mode. In addition, there is no reflection of external light (light incident on the absorptive polarizing plate 50 from the front surface side) by the reflective polarizing plate 40, thereby preventing low visibility of the image provided by the liquid crystal panel 1a for display. In the transparent mode, the liquid crystal panel 1a for display may be in a non-display state.

### (Mirror Mode)

The mirror mode is achieved when voltage is applied to the liquid crystal panel 1. This will be specifically described below.

The liquid crystal panel 1a for display is in a non-display state. Here, the liquid crystal panel 1a for display preferably provides no display entirely or partially. Providing no display may be achieved by emitting no display light from the liquid crystal display part 2a by providing black display or, turning out or toning down the backlight 60.

Meanwhile, light incident on the absorptive polarizing plate 50 from the front surface side that vibrates in the direction parallel to the transmission axis of the absorptive polarizing plate 50 passes through the absorptive polarizing plate 50 to be converted into linearly polarized light. The polarization state of the linearly polarized light emerging from the absorptive polarizing plate 50 is altered (coloring mode) by the birefringence effects of the liquid crystal panel 1 as it passes through the liquid crystal panel 1 (with voltage applied), and the linearly polarized light is converted into elliptically polarized light. The elliptically polarized light emerging from the liquid crystal panel 1 that vibrates in the direction parallel to the transmission axis of the reflective polarizing plate 40 passes through the reflective polarizing plate 40 and is absorbed by the absorptive polarizing plate 50a or members of the liquid crystal panel 1a for display, such as a color filter layer and black matrix. In contrast, the elliptically polarized light emerging from the liquid crystal panel 1 that vibrates in the direction perpendicular to the transmission axis (parallel to the reflection axis) of the reflective polarizing plate 40 is reflected by the reflective polarizing plate 40 as linearly polarized light. The polarization state of the linearly polarized light reflected by the reflective polarizing plate 40 is altered by the birefringence effects of the liquid crystal panel 1 as it passes through the liquid crystal panel 1, and the linearly polarized light is converted into elliptically polarized light. The elliptically polarized light emerging from the liquid crystal panel 1 that vibrates in the direction parallel to the transmission axis of the absorptive polarizing plate 50 passes through the absorptive polarizing plate 50 to be emitted as reflected light to the front surface side. The elliptically polarized light emerging from the liquid crystal panel 1 that vibrates in the direction perpendicular to the transmission axis (parallel to the absorption axis) of the absorptive polarizing plate 50 is absorbed by the absorptive polarizing plate 50.

Thereby, a mirror image is visible by reflected light in the mirror mode. In addition, the liquid crystal panel 1 includes segment electrodes. Voltage application to part(s) of the pixels thus enables display of information such as letters and images by reflected light. Here, variation in polarization state caused by the birefringence and variations in transmittance and reflectance that accompany the polarization state variation involve large wavelength dispersion. The intensity of reflected light thus changes according to the wavelength. Namely, the reflected light is colored in the mirror mode. In the pixels with no voltage applied, an image provided by the liquid crystal panel 1a for display is visible.

In the following, the case is described where the transmission axis of the reflective polarizing plate 40 and the transmission axis of the absorptive polarizing plate 50 are perpendicular to each other in the switchable mirror panel 2. In the liquid crystal display part 2a, the transmission axis of the absorptive polarizing plate 50a and the transmission axis of the absorptive polarizing plate 50b are perpendicular to each other. The transmission axis of the reflective polarizing plate 40 and the transmission axis of the absorptive polarizing plate 50b are parallel to each other.

### (Transparent Mode)

The transparent mode is achieved when voltage is applied to the liquid crystal panel 1. This will be specifically described below.

When the liquid crystal panel 1a for display provides an image (display mode), linearly polarized light emitted from the liquid crystal display part 2a (linearly polarized light emerging from the absorptive polarizing plate 50b) passes through the reflective polarizing plate 40 whose transmission axis is parallel to the transmission axis of the absorptive polarizing plate 50b. The polarization state of the linearly polarized light emerging from the reflective polarizing plate 40 is altered by the birefringence effects of the liquid crystal panel 1 (coloring mode) as it passes through the liquid crystal panel 1 (with voltage applied), and the linearly polarized light is converted into elliptically polarized light. The elliptically polarized light emerging from the liquid crystal panel 1 that vibrates in the direction parallel to the transmission axis of the absorptive polarizing plate 50 passes through the absorptive polarizing plate 50. In contrast, the elliptically polarized light emerging from the liquid crystal panel 1 that vibrates in the direction perpendicular to the transmission axis (parallel to the absorption axis) of the absorptive polarizing plate 50 is absorbed by the absorptive polarizing plate 50. Thereby, despite the existence of the switchable mirror panel 2, the image provided by the liquid crystal panel 1a for display is visible as in the case without the switchable mirror panel 2.

Thereby, the image provided by the liquid crystal panel 1a for display is visible in the transparent mode. Here, variation in polarization state caused by the birefringence and variation in transmittance that accompanies the polarization state variation involve large wavelength dispersion. Light emitted from the liquid crystal display part 2a thus changes its intensity according to the wavelength. Namely, the emitted light is colored in the transparent mode. In the transparent mode, the liquid crystal panel 1a for display may be in a non-display state.

### (Mirror Mode)

The mirror mode is achieved when no voltage is applied to the liquid crystal panel 1. This will be specifically described below.

The liquid crystal panel 1a for display is in a non-display state. Here, the liquid crystal panel 1a for display preferably provides no display entirely or partially. Providing no display may be achieved by emitting no display light from the liquid crystal display part 2a by providing black display or, turning out or toning down the backlight 60.

Light incident on the absorptive polarizing plate 50 from the front surface side that vibrates in the direction parallel to the transmission axis of the absorptive polarizing plate 50 passes through the absorptive polarizing plate 50 to be converted into linearly polarized light. Here, the liquid crystal panel 1 has zero retardation. The linearly polarized light emerging from the absorptive polarizing plate 50 thus passes through the liquid crystal panel 1 (with no voltage applied) while holding its polarization state (non-coloring mode). The linearly polarized light emerging from the liquid crystal panel 1 is reflected by the reflective polarizing plate 40 whose reflection axis is parallel to the transmission axis of the absorptive polarizing plate 50. The linearly polarized light reflected by reflective polarizing plate 40 passes through the liquid crystal panel 1 and then the absorptive polarizing plate 50 to be emitted as reflected light to the front surface side.

Thereby, a mirror image is visible by reflected light in the mirror mode. In addition, the liquid crystal panel 1 includes segment electrodes. No voltage application to part(s) of the pixels enables display of information such as letters and images by reflected light. In this case, reflected light is colorless (achromatic). In the pixels with voltage applied, an image provided by the liquid crystal panel 1a for display is visible.

The liquid crystal display part 2a and the switchable mirror panel 2 may be bonded together with a pressure-sensitive adhesive in between. Examples of the pressure-sensitive adhesive include an optically clear adhesive (OCA) sheet.

FIG. 4 is a conceptual view of the switchable mirror display of Embodiment 3. A switchable mirror display 3 includes, in the following order from the back surface side to the front surface side, a backlight 60, a liquid crystal display part 2a, and the switchable mirror panel 2. The liquid crystal display part 2a includes, in the following order from the back surface side to the front surface side, the absorptive polarizing plate 50a, the liquid crystal panel 1a for display, and the absorptive polarizing plate 50b.

In the tolan liquid crystal compound contained in the liquid crystal layer 30 of the switchable mirror panel 2, a n bond is cleaved by UV light or the like emitted from the backlight 60 to generate radicals and ions. Here, the switchable mirror display 3 of the present embodiment includes the liquid crystal display part 2a between the switchable mirror panel 2 and the backlight 60. Furthermore, the liquid crystal display part 2a includes the liquid crystal panel 1a for display held between two absorptive polarizing plates 50a and 50b. The two absorptive polarizing plates 50a and 50b in the liquid crystal display part 2a, which absorb UV light with a wavelength up to 380 nm, can slow down the generation speed of radicals and ions derived from the tolan liquid crystal compound contained in the liquid crystal layer 30 of the switchable mirror panel 2.

The present invention is described below in more detail based on examples and comparative examples. The examples, however, are not intended to limit the scope of the present invention.

### Example 1

In Example 1, the liquid crystal panel 1 of Embodiment 1 was actually produced by the following method.

First, in order to produce a passive driving liquid crystal panel 1, a pair of the substrates 10 and 20 each including stripe-patterned ITO electrodes was prepared. To the substrates 10 and 20, a solvent containing a vertical alignment polymer represented by the formula (P-1-1) was applied, pre-baked at 90° C. for five minutes, and then post-baked at 200° C. for 40 minutes. Through this baking treatment, the vertical alignment films 11 (film thickness: 50 nm to 160 nm) were formed which included the vertical alignment polymer represented by the formula (P-1-1) whose main chain was a polyimide and whose side chain terminal was a saturated aliphatic functional group.

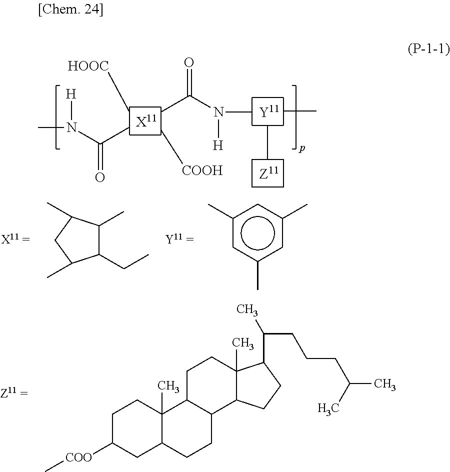

Next, the vertical alignment films 11 were subjected to rubbing treatment such that the rubbing directions of the films after bonding were anti-parallel to each other. To one of the substrates, a UV curing sealant (Sekisui Chemical Co., Ltd., Photolec® S—WB) was applied in a pattern using a dispenser. To a prescribed position on the other substrate, a negative liquid crystal material (nematic-isotropic transition point (Tni) of the liquid crystal material=90° C., Δn=0.19, Δε=−5) containing the tolan liquid crystal compound represented by the formula (T) was applied dropwise.

Subsequently, the substrates 10 and 20 were bonded together under vacuum and the sealant was cured with UV light. In order to eliminate the flow-induced alignment of the liquid crystal compound in the thus-obtained liquid crystal cell, the liquid crystal cell was heated at 130° C. for 40 minutes, whereby realignment treatment was performed to transfer the phase of the liquid crystal compound to an isotropic phase. The liquid crystal cell was cooled to room temperature, whereby a VA-ECB-mode liquid crystal panel 1 was obtained.

### Comparative Example 1

A liquid crystal panel of Comparative Example 1 was produced in the same manner as in Example 1, except that a different alignment film material from that of Example 1 was used. In the present comparative example, a polymer represented by the formula (PR-1-1) was used in place of the vertical alignment polymer represented by the formula (P-1-1) in Example 1, and an alignment film (film thickness: 50 nm to 160 nm) containing the polymer represented by the formula (PR-1-1) was formed on each substrate.

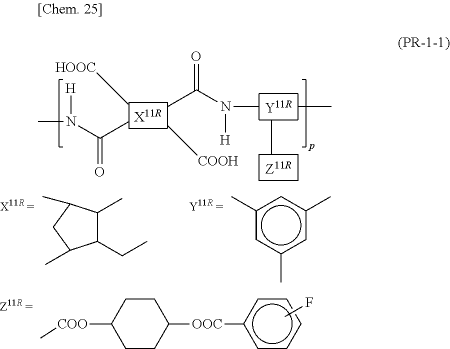

### Backlight Exposure Test of Example 1 and Comparative Example 1

First, initial residual DC voltage values were determined by the flicker elimination method before leaving the liquid crystal panels of Example 1 and Comparative Example 1 on the backlight. The residual DC voltage values were determined after applying a 2 V DC offset at 70° C. for two hours. Also, as indicators of impurity generation, initial VHRs were determined before leaving the liquid crystal panels of Example 1 and Comparative Example 1 on the backlight. The VHRs were determined under the condition of 1 V and 70° C. using a 6254-type VHR measurement system available from Toyo Technica Co., Ltd. Thus, the initial residual DC voltage values and initial VHRs before leaving the liquid crystal panels of Example 1 and Comparative Example 1 on the backlight were obtained. For determination of the VHRs and residual DC voltage values, a passive driving single pixel test cell was used. The residual DC voltage is also expressed as rDC.

Subsequently, the liquid crystal panels of Example 1 and Comparative Example 1 were left on the backlight and the residual DC voltage values and VHRs were determined by the following method. Specifically, the liquid crystal panels produced in Example 1 and Comparative Example 1 were each left on the backlight 60 for 100 hours under the following two conditions, and the residual DC voltage values and VHRs were determined by the same method as in the above.

### <Condition 1>

A FFS-mode liquid crystal display part including paired polarizing plates and a liquid crystal panel for display provided with a color filter substrate was placed on the backlight 60. The liquid crystal panel produced in Example 1 or Comparative Example 1 was placed directly on the liquid crystal display part. The FFS-mode liquid crystal display part was the same as the liquid crystal display part 2a used in the following Example 4.

### <Condition 2>

The liquid crystal panel produced in Example 1 or Comparative Example 1 was placed directly on the backlight 60.

Table 1 shows the results of the backlight exposure test of Example 1 and Comparative Example 1.

TABLE 1

| | | Initial stage | | After backlight | |
|---|---|---|---|---|---|
| | | rDC | | exposure | |
| | Test method | (mV) | VHR (%) | rDC (mV) | VHR (%) |
| Example 1 | Condition 1 | 20 | 98.4 | 30 | 97.6 |
| | Condition 2 | 20 | 98.2 | 70 | 96.1 |
| Comparative | Condition 1 | 40 | 98.1 | 120 | 96.8 |
| Example 1 | Condition 2 | 40 | 98.1 | 180 | 94.5 |

As shown in Table 1, the liquid crystal panel 1 of Example 1, in which the vertical alignment films 11 contained a vertical alignment polymer whose side chain was a saturated aliphatic functional group, presented an initial residual DC value of as small as 20 mV in both Condition 1 and Condition 2.

In Condition 1 where the liquid crystal panel 1 of Example 1 was placed on the backlight 60 via the liquid crystal display part 2a, the residual DC voltage value after 100-hour exposure was 30 mV which showed a little increase (deterioration) from the initial residual DC voltage value. In contrast, in Condition 2 where the liquid crystal panel 1 of Example 1 was placed directly on the backlight 60 without the liquid crystal display part 2a, the residual DC voltage value after 100-hour exposure increased to 70 mV. Additionally, in Condition 2, the VHR decreased to 96% level, which presumably indicates that backlight illumination promoted radicalization and ionization of the tolan liquid crystal compound.

Still, the residual DC voltage values of the liquid crystal panel 1 of Example 1 are lower than those of the liquid crystal panel of Comparative Example 1. The reason for this is presumably as follows. That is, allowing a side chain terminal of the vertical alignment polymer contained in the vertical alignment films 11 to have a saturated aliphatic functional group suppresses the n-n interaction between the vertical alignment films 11 and radicals and ions derived from the tolan liquid crystal compound in the liquid crystal layer 30 both at the initial stage and after the backlight exposure. This presumably indicates that radicals and ions that are derived from the tolan liquid crystal compound and are generated through 100-hour exposure with the backlight 60 hardly adsorb on the surfaces of the vertical alignment films 11. In Example 1, the residual DC voltage value after 100-hour exposure with the backlight 60 in Condition 1 was lower than that in Condition 2. This is presumably because, in Condition 1, the liquid crystal display part 2a was placed between the liquid crystal panel 1 of Example 1 and the backlight 60 so that UV light emitted from the backlight 60 was effectively absorbed by the liquid crystal display part 2a to slow down the speed of the radicalization and ionization of the tolan liquid crystal compound in the liquid crystal panel 1 of Example 1.

In the case of the liquid crystal panel of Comparative Example 1, in which a side chain terminal of the vertical alignment polymer in the vertical alignment films was an aromatic group, the initial VHRs were similar to those of Example 1, while the initial residual DC voltage values were 40 mV, which were slightly larger than those of Example 1. In Condition 1 where the liquid crystal panel of Comparative Example 1 was placed on the backlight 60 via the liquid crystal display part 2a, the residual DC voltage value after 100-hour exposure increased to 120 mV, while the VHR declined to 96.8%. In Condition 2 where the liquid crystal panel of Comparative Example 1 was placed directly on the backlight 60 without the liquid crystal display part 2a, the residual DC voltage value after 100-hour exposure increased to 180 mV, while the VHR declined to 94.5%. This presumably indicates that introducing an aromatic group into a side chain terminal of the vertical alignment polymer in the vertical alignment films allowed impurities that seemed to be radicals and ions derived from the tolan liquid crystal compound to easily adsorb on the alignment film, and thereby the residual DC voltage values increased. The backlight illumination presumably promoted radicalization and ionization of the tolan liquid crystal compound to reduce the VHRs.

### Example 2

A liquid crystal panel 1 of Example 2 was produced in the same manner as in Example 1, except that a different alignment film material was used and the method of alignment treatment was changed. In Example 2, a vertical alignment polymer for photoalignment treatment represented by the following formula (P-1-2) was used in place of the vertical alignment polymer for rubbing treatment represented by the formula (P-1-1) used in Example 1, and vertical alignment films 11 (film thickness: 50 nm to 160 nm) that contained the vertical alignment polymer represented by the formula (P-1-2) were formed on each substrate.

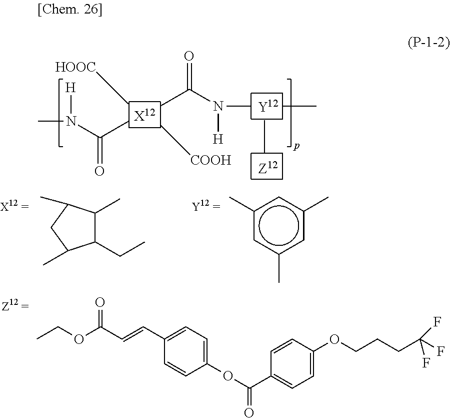

In the alignment treatment step, photoalignment treatment was performed using linearly polarized light such that the light irradiation directions of the vertical alignment films 11 after bonding were anti-parallel to each other.

### Comparative Example 2

A liquid crystal panel of Comparative Example 2 was produced in the same manner as in Example 2 except that a different alignment film material from that of Example 2 was used. In Comparative Example 2, a vertical alignment polymer for photoalignment treatment represented by the formula (PR-1-2) was used in place of the vertical alignment polymer for photoalignment treatment represented by the formula (P-1-2) used in Example 2, and a vertical alignment film (film thickness: 50 nm to 160 nm) containing the vertical alignment polymer represented by the formula (PR-1-2) was formed on each substrate.

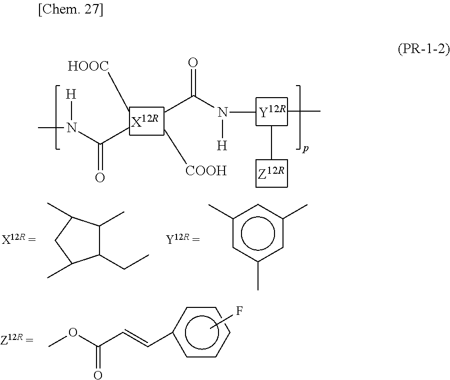

### Backlight Exposure Test of Example 2 and Comparative Example 2

Backlight exposure tests were performed under the same conditions as in Example 1 and Comparative Example 1. Table 2 shows the results.

TABLE 2

| | | Initial stage | | After backlight | |
|---|---|---|---|---|---|
| | | rDC | | exposure | |
| | Test method | (mV) | VHR (%) | rDC (mV) | VHR (%) |
| Example 2 | Condition 1 | 60 | 98.8 | 70 | 97.3 |
| | Condition 2 | 60 | 98.6 | 110 | 95.5 |
| Comparative | Condition 1 | 80 | 98.6 | 190 | 95.9 |
| Example 2 | Condition 2 | 80 | 98.7 | 270 | 93.2 |

As shown in Table 2, the liquid crystal panel 1 of Example 2, in which the vertical alignment films 11 contained a vertical alignment polymer whose side chain was a saturated aliphatic functional group, presented initial residual DC voltage values of as relatively small as 60 mV in both Condition 1 and Condition 2.

In Condition 1 where the liquid crystal panel 1 of Example 2 was placed on the backlight 60 via the liquid crystal display part 2a, the residual DC voltage value after 100-hour exposure was 70 mV which showed a little increase (deterioration) from the initial residual DC voltage value. In contrast, in Condition 2 where the liquid crystal panel 1 of Example 2 was placed directly on the backlight 60 without the liquid crystal display part 2a, the residual DC voltage value after 100-hour exposure increased to 110 mV. Additionally, in Condition 2, the VHR decreased to 95% level, which presumably indicates that backlight illumination promoted radicalization and ionization of the tolan liquid crystal compound.

Still, the residual DC voltage values of the liquid crystal panel 1 of Example 2 are lower than those of the liquid crystal panel of Comparative Example 2. The reason for this is presumably as follows. That is, allowing the side chain terminal of the vertical alignment polymer contained in the vertical alignment films 11 to have a saturated aliphatic functional group suppresses the n-n interaction between the vertical alignment films 11 and radicals and ions derived from the tolan liquid crystal compound in the liquid crystal layer 30 both at the initial stage and after backlight exposure. This presumably indicates that radicals and ions that are derived from the tolan liquid crystal compound and are generated through 100-hour exposure with the backlight 60 hardly adsorb on the surfaces of the vertical alignment films 11. In Example 2, the residual DC voltage value after 100-hour exposure with the backlight 60 in Condition 1 was lower than that in Condition 2. This is presumably because, in Condition 1, the liquid crystal display part 2a was placed between the liquid crystal panel 1 of Example 2 and the backlight 60 so that UV light emitted from the backlight 60 was effectively absorbed by the liquid crystal display part 2a to slow down the speed of the radicalization and ionization of the tolan liquid crystal compound in the liquid crystal panel 1 of Example 2.

In the case of the liquid crystal panel of Comparative Example 2, where a polymer represented by the formula (PR-1-2) containing a photofunctional group (cinnamate group) at a side chain terminal was used as a vertical alignment polymer contained in the vertical alignment film, the initial VHRs were similar to those of Example 2, while the initial residual DC voltage values were 80 mV, which were slightly larger than those of Example 1. In Condition 1 where the liquid crystal panel of Comparative Example 2 was placed on the backlight 60 via the liquid crystal display part 2a, the residual DC voltage value after 100-hour exposure increased to 190 mV, while the VHR declined to 95.9%. In Condition 2 where the liquid crystal panel of Comparative Example 2 was placed directly on the backlight 60 without the liquid crystal display part 2a, the residual DC voltage value after 100-hour exposure increased to 270 mV, while the VHR declined to 93.2%. This presumably indicates that introducing an aromatic group into the side chain terminal of the vertical alignment polymer in the vertical alignment films allowed impurities that seemed to be radicals and ions derived from the tolan liquid crystal compound to easily adsorb on the alignment film to increase the residual DC voltage values.

### Example 3

A liquid crystal panel 1 of Example 3 was produced in the same manner as in Example 2, except that a different alignment film material and liquid crystal compound were used and the temperature of post-baking of the alignment film was changed. In Example 3, a vertical alignment polymer for photoalignment treatment represented by the following formula (P-5-1) was used in place of the vertical alignment polymer for photoalignment treatment represented by the formula (P-1-2) used in Example 2, and vertical alignment films 11 (film thickness: 50 nm to 160 nm) that contained the vertical alignment polymer represented by the formula (P-5-1) were formed on each substrate. Additionally, in Example 3, the temperature of post-baking the vertical alignment film was changed to 230° C.

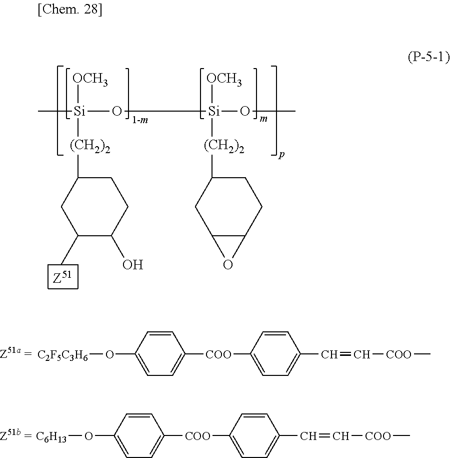

In the formulas, Z⁵¹ is at least one of Z^{51a} and Z^{51b}, and m is 0.5.

In Example 3, a negative liquid crystal material (nematic-isotropic transition point of the liquid crystal material (Tni))=90° C., Δn=0.20, Δε=−3) containing a tolan liquid crystal compound represented by the formula (T) was used, which was different from the tolan liquid crystal compound in Example 1.

### Comparative Example 3

A liquid crystal panel of Comparative Example 3 was produced in the same manner as in Example 3 except that a different alignment film material was used. In the present comparative example, a polymer represented by the formula (PR-5-1) was used in place of the vertical alignment polymer represented by the formula (P-5-1) used in Example 3, and alignment films (film thickness: 50 nm to 160 nm) containing the polymer represented by the formula (PR-1-1) were formed on each substrate.

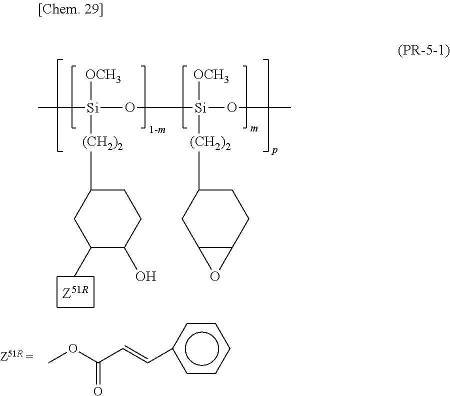

In the formula, m is 0.5.

### Backlight Exposure Test of Example 3 and Comparative Example 3

Backlight exposure tests were performed under the same conditions as in Example 1 and Comparative Example 1. Table 3 shows the results.

TABLE 3

| | | Initial stage | | After backlight | |
|---|---|---|---|---|---|
| | | rDC | | exposure | |
| | Test method | (mV) | VHR (%) | rDC (mV) | VHR (%) |
| Example 3 | Condition 1 | 10 | 99.1 | 20 | 97.8 |
| | Condition 2 | 10 | 99.1 | 60 | 95.5 |
| Comparative | Condition 1 | 30 | 99.0 | 110 | 96.3 |
| Example 3 | Condition 2 | 30 | 99.1 | 190 | 94.2 |

As shown in Table 3, the liquid crystal panel 1 of Example 3, in which the vertical alignment films 11 contained a vertical alignment polymer whose side chain was a saturated aliphatic functional group, presented initial residual DC voltage values of as extremely small as 10 mV in both Condition 1 and Condition 2.

In Condition 1 where the liquid crystal panel 1 of Example 3 was placed on the backlight 60 via the liquid crystal display part 2a, the residual DC voltage value after 100-hour exposure was 20 mV which was extremely small and showed a little increase (deterioration) from the initial residual DC voltage value. In contrast, in Condition 2 where the liquid crystal panel 1 of Example 3 was placed directly on the backlight 60 without the liquid crystal display part 2a, the residual DC voltage value after 100-hour exposure increased to 60 mV. Additionally, in Condition 2, the VHR decreased to 95% level, which presumably indicates that backlight illumination promoted radicalization and ionization of the tolan liquid crystal compound.

Still, the residual DC voltage values of the liquid crystal panel 1 of Example 3 are lower than those of the liquid crystal panel of Comparative Example 3. The reason for this is presumably as follows. That is, allowing the side chain terminal of the vertical alignment polymer contained in the vertical alignment films 11 to have a saturated aliphatic functional group suppresses the n-n interaction between the vertical alignment films 11 and radicals and ions derived from the tolan liquid crystal compound in the liquid crystal layer 30 both at the initial stage and after backlight exposure. This presumably indicates that radicals and ions that are derived from the tolan liquid crystal compound and are generated through 100-hour exposure with the backlight 60 hardly adsorb on the surfaces of the vertical alignment films 11.

In Example 3, the residual DC voltage value after 100-hour exposure with the backlight 60 in Condition 1 was lower than that in Condition 2. This is presumably because, in Condition 1, the liquid crystal display part 2a was placed between the liquid crystal panel 1 of Example 2 and the backlight 60 so that UV light emitted from the backlight 60 was effectively absorbed by the liquid crystal display part 2a to slow down the speed of the radicalization and ionization of the tolan liquid crystal compound in the liquid crystal panel 1 of Example 3. A comparison between the liquid crystal panel of Example 2, in which the main chain of the vertical alignment polymer in the vertical alignment films 11 was a polyimide structure, and the liquid crystal panel of Example 3, in which the main chain of the polymer is a siloxane structure, showed that the residual DC voltage values were more suppressed in Example 3. This showed that allowing the main chain of the vertical alignment polymer in the vertical alignment films 11 to have a siloxane structure enabled low residual DC voltage values.

In the case of the liquid crystal panel of Comparative Example 3, where a polymer represented by the formula (PR-5-1) containing a photofunctional group (cinnamate group) at the side chain terminal is used as a vertical alignment polymer contained in the vertical alignment film, the initial VHRs were similar to those of Example 3, while the initial residual DC voltage values increased to 30 mV. In Condition 1 where the liquid crystal panel of Comparative Example 3 was placed on the backlight 60 via the liquid crystal display part 2a, the residual DC voltage value after 100-hour exposure increased to 110 mV, while the VHR declined to 96.3%. In Condition 2 where the liquid crystal panel of Comparative Example 3 was placed directly on the backlight 60 without the liquid crystal display part 2a, the residual DC voltage value after 100-hour exposure increased to 190 mV, while the VHR declined to 94.2%. This presumably indicates that introducing an aromatic group into the side chain terminal of the vertical alignment polymer in the vertical alignment films allowed impurities that seemed to be radicals and ions derived from the tolan liquid crystal compound to easily adsorb on the alignment film to increase the residual DC voltage values. A comparison between the liquid crystal panel of Comparative Example 2, in which the main chain of the polymer in the alignment films was a polyimide structure, and the liquid crystal panel of Comparative Example 3, in which the main chain of the polymer is a siloxane structure, showed that the residual DC voltage values were more suppressed in Comparative Example 3. This showed that allowing the main chain of the polymer in the alignment films to have a siloxane structure enabled low residual DC voltage values.

### Example 4

In Example 4, the switchable mirror display 3 of Embodiment 3 was produced by the following method.

First, a passive driving switchable mirror panel 2 was produced through the following steps. A pair of the substrates (back surface side: the first substrate 10, front surface side (viewer's side): the second substrate 20) each including ITO electrodes was prepared. To the substrates 10 and 20, a solvent containing a vertical alignment polymer represented by the formula (P-1-1) was applied, pre-baked at 90° C. for five minutes, and then post-baked at 200° C. for 40 minutes. Through this baking treatment, the vertical alignment films 11 (film thickness: 50 nm to 160 nm) were formed which included the vertical alignment polymer represented by the formula (P-1-1) whose main chain was a polyimide and whose side chain terminal was a saturated aliphatic functional group.

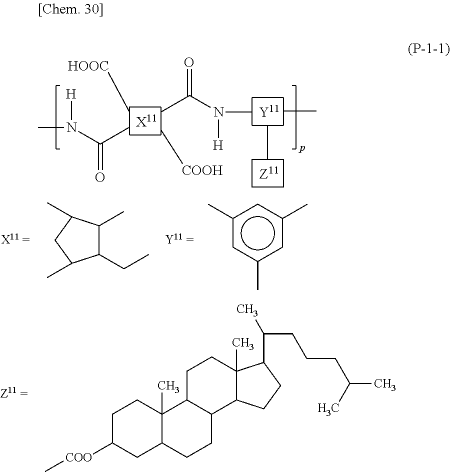

Next, the vertical alignment films 11 were subjected to rubbing treatment such that the rubbing directions of the films after bonding were anti-parallel to each other. To the second substrate 20, a UV curing sealant (Sekisui Chemical Co., Ltd., Photolec® S—WB) was applied in a pattern using a dispenser. To a prescribed position on the first substrate 10, a negative liquid crystal material (nematic-isotropic transition point (Tni) of the liquid crystal material=90° C., Δn=0.19, Δn=−5) containing the tolan liquid crystal compound represented by the formula (T) was applied dropwise.

Subsequently, the substrates 10 and 20 were bonded together under vacuum and the sealant was cured with UV light. In order to eliminate the flow-induced alignment of the liquid crystal compound in the thus-obtained liquid crystal cell, the liquid crystal cell was heated at 130° C. for 40 minutes, whereby realignment treatment was performed to transfer the phase of the liquid crystal compound to an isotropic phase. The liquid crystal cell was cooled to room temperature, whereby a VA-ECB-mode liquid crystal panel 1 was obtained.

The absorptive polarizing plate 50 was bonded to the surface on the side opposite to the liquid crystal layer 30 of the second substrate 20 in the obtained liquid crystal panel 1, and the reflective polarizing plate 40 (available from 3M Ltd., DBEF®) was bonded to the surface on the side opposite to the liquid crystal layer 30 of the first substrate 10, thereby providing the switchable mirror panel 2. The absorptive polarizing plate was a plate obtained by adsorption alignment of a dichroic anisotropic material, such as an iodine complex, on a polyvinyl alcohol (PVA) film.

The liquid crystal display part 2a was produced by placing the absorptive polarizing plate 50a on the back surface side of a FFS-mode liquid crystal panel 1a for display available from Sharp Corporation and the absorptive polarizing plate 50b on the front surface side thereof. In other words, the liquid crystal display part 2a includes the active substrate 10b, the color filter substrate 20b, the liquid crystal layer 30a held between the active substrate 10b and the color filter substrate 20b, and the absorptive polarizing plates 50a and 50b disposed on the respective surfaces on the side opposite to the liquid crystal layer 30a of the active substrate 10b and of the color filter substrate 20b. In the liquid crystal display part 2a, the active substrate 10b and the color filter substrate 20b have undergone rubbing treatment in anti-parallel directions each other, and the liquid crystal compound of the liquid crystal layer 30a is horizontally aligned. One of the two substrates 10a and 20a constituting the liquid crystal display part 2a includes upper pixel electrodes with slits and lower pixel electrodes without slits via a transparent insulating film such as a nitride film. Voltage application between the upper and lower pixel electrodes generates fringe electric fields. In a FFS-mode display, the fringe electric fields vary the alignment of the liquid crystal compound in a substrate plane to control the amount of transmitted light.

Finally, the backlight 60, the liquid crystal display part 2a, and the switchable mirror panel 2 were stacked in this order to produce the switchable mirror display 3. In the present example, the liquid crystal display part 2a and the switchable mirror panel 2 were stacked with only an air layer in between, but these members may be bonded with an OCA or the like. Alternatively, the liquid crystal display part 2a may be replaced by a display device emitting polarized light such as an organic electroluminescence display device including an absorptive circularly polarizing plate for antireflection and a MEMS display including a polarizing plate.

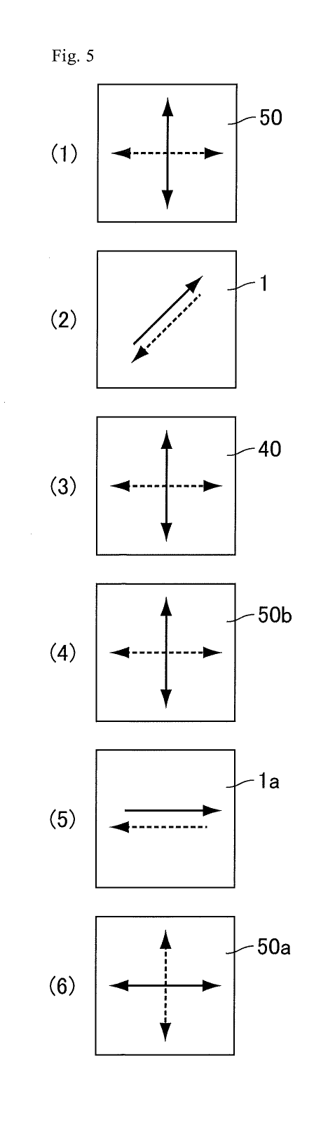

FIGS. 5(1) to 5(6) are drawings showing the polarization states of a switchable mirror display of Example 4: FIG. 5(1) is a drawing concerning a front surface side absorptive polarizing plate of a switchable mirror panel; FIG. 5(2) is a drawing concerning a liquid crystal panel of the switchable mirror panel; FIG. 5(3) is a drawing concerning a back surface side reflective polarizing plate of the switchable mirror panel; FIG. 5(4) is a drawing concerning a front surface side absorptive polarizing plate of a liquid crystal display part; FIG. 5(5) is a drawing concerning a FFS-mode liquid crystal panel for display of the liquid crystal display part; and FIG. 5(6) is a drawing concerning a back surface side absorptive polarizing plate of the liquid crystal display part. In FIGS. 5(1), 5(4), and 5(6), each solid arrow represents a transmission axis, and each dashed arrow represents an absorption axis. In FIGS. 5(2) and 5(5), each solid arrow represents the rubbing direction of the front surface side substrate, and each dashed arrow represents the rubbing direction of the back surface side substrate. Both substrates on the front surface side and the back surface side are rubbed in a 45° direction. In FIG. 5(3), the solid arrow represents the transmission axis of the reflective polarizing plate, and the dashed arrow represents the reflection axis thereof.

The following describes the transmission axis of each polarizing plate used in the switchable mirror display 3 produced in Example 4. As shown in FIGS. 5(1) to 5(6), in the switchable mirror panel 2 in the switchable mirror display 3 of Example 4, the transmission axis of the reflective polarizing plate 40 and the transmission axis of the absorptive polarizing plate 50 are parallel to each other. In the liquid crystal display part 2a, the transmission axis of the absorptive polarizing plate 50a and the transmission axis of the absorptive polarizing plate 50b are perpendicular to each other. The transmission axis of the reflective polarizing plate 40 in the switchable mirror panel 2 and the transmission axis of the absorptive polarizing plate 50b in the liquid crystal display part 2a are parallel to each other. Thereby, the switchable mirror panel 2 with no voltage applied operates in the transparent mode to display an image provided by the liquid crystal display part 2a. Meanwhile, the switchable mirror panel 2 with voltage applied operates in the mirror mode to allow the mirror image by reflected light to be visible.

The operation of the switchable mirror display 3 produced in Example 4 is further described.

### <Operation in No-Voltage Applied State>

In the switchable mirror panel 2, in the no-voltage applied state, linearly polarized light emitted from the absorptive polarizing plate 50b, which is placed on the front surface (viewer) side of the liquid crystal display part 2a including the FFS-mode liquid crystal panel 1a for display, passes through the transmission axis of the reflective polarizing plate 40 of the switchable mirror panel 2 including the VA-ECB-mode liquid crystal panel 1. Here, the VA-ECB-mode liquid crystal panel 1 of the switchable mirror panel 2 has zero retardation (birefringence). Thus, the light transmitted through the reflective polarizing plate 40 passes through, while holding its polarization state, the transmission axis of the absorptive polarizing plate 50 placed on the front surface (viewer) side of the switchable mirror panel 2, to reach the eyes of a viewer. In other words, despite the existence of the VA-ECB-mode liquid crystal panel 1, the reflective polarizing plate 40, and the absorptive polarizing plate 50 which constitute the switchable mirror panel 2, the viewer can see the display provided by the FFS-mode liquid crystal panel 1a for display of the liquid crystal display part 2a as in the case without those components.

Here, external light incident from the viewer side passes through the absorptive polarizing plate 50 in the switchable mirror panel 2 to be converted into linearly polarized light and reaches the reflective polarizing plate 40 in the switchable mirror panel 2 without being influenced by the birefringence, i.e., holding the polarization state of the linearly polarized light. The transmission axis of the reflective polarizing plate 40 in the switchable mirror panel 2 and the transmission axis of the absorptive polarizing plate 50 in the switchable mirror panel 2 are parallel to each other. Thus, the linearly polarized light having reached the reflective polarizing plate 40 passes through the reflective polarizing plate 40 without being reflected by the reflective polarizing plate 40. Then, the linearly polarized light travels through the components such as the absorptive polarizing plate 50b and the FFS-mode liquid crystal cell 1a in the liquid crystal display part 2a toward the back surface side and is absorbed by the absorbers such as the absorptive polarizing plate 50a placed on the backmost surface side in the liquid crystal display part 2a and a color filter and a black mask in the FFS-mode liquid crystal panel 1a for display. Thus, almost no light component travels back to the viewer side again as reflected light.

As described, when the switchable mirror panel 2 including the VA-ECB-mode liquid crystal panel 1 is operated in the no-voltage applied state, the viewer can see the display provided by the liquid crystal display part 2a including the FFS-mode liquid crystal panel 1a for display. Undesired reflection of external light by the reflective polarizing plate, which lowers the visibility in a bright place, is thus prevented.

### <Operation in Voltage Applied State>

When the switchable mirror panel 2 is operated in the mirror mode, voltage is applied to the switchable mirror panel 2 including the VA-ECB-mode liquid crystal panel 1. Since the function and operation as the mirror mode are important, the liquid crystal display part 2a including the FFS-mode liquid crystal panel 1a for display preferably provides no display entirely or partly (provides black display or turns the backlight off or down) in the mirror mode.

External light incident on the switchable mirror panel 2 including the VA-ECB-mode liquid crystal panel 1 from the front surface (viewer) side passes the absorptive polarizing plate 50 in the switchable mirror panel 2 to be converted into linearly polarized light. The linearly polarized light is then converted into elliptically polarized light by the birefringence of the VA-ECB-mode liquid crystal panel 1 to reach the reflective polarizing plate 40 in the switchable mirror panel 2. The elliptically polarized light that vibrates in the direction parallel to the transmission axis of the reflective polarizing plate 40 passes toward the back surface side and is absorbed by the FFS-mode liquid crystal panel 1a for display in the liquid crystal display part 2a. The elliptically polarized light that vibrates in the direction parallel to the reflection axis of the reflective polarizing plate 40 in the switchable mirror panel 2 is reflected to the front surface (viewer) side as linearly polarized light and is converted into elliptically polarized light again by the birefringence of the VA-ECB-mode liquid crystal panel 1 to reach the absorptive polarizing plate 50 in the switchable mirror panel 2. The elliptically polarized light that vibrates in the direction parallel to the transmission axis of the absorptive polarizing plate 50 in the switchable mirror panel 2 passes toward the front surface (viewer) side while holding its polarization state to reach the eyes of the viewer as reflected light. The elliptically polarized light that vibrates in the direction perpendicular to the transmission axis (parallel to the absorption axis) of the absorptive polarizing plate 50 in the switchable mirror panel 2 is absorbed.

Variation in polarization state caused by the birefringence and variations in transmittance and reflectance that relates to the polarization state variation involve large wavelength dispersion (wavelength dependency). The intensity of reflected light thus varies according to the wavelength. Accordingly, reflected external light in the switchable mirror display 3 of Example 4 is colored.

### Backlight Exposure Test in Example 4

Before turning on the backlight 60 of the switchable mirror display 3 produced in Example 4, the initial residual DC voltage value and VHR of the switchable mirror panel 2 in the switchable mirror display 3 produced in Example 4 were determined by the same method as in Example 1.

Subsequently, the backlight 60 of the switchable mirror display 3 produced in Example 4 was turned on and left it stand for 100 hours, and the residual DC voltage value and VHR of the switchable mirror panel 2 were determined by the same method as in the above. Table 4 shows the results.

TABLE 4

| | | | After backlight | |
|---|---|---|---|---|
| | Initial stage | | exposure | |
| | rDC (mV) | VHR (%) | rDC (mV) | VHR (%) |
| Switchable | 20 | 98.3 | 30 | 97.4 |
| mirror panel | | | | |
| of Example 4 | | | | |

The initial residual DC voltage value of the switchable mirror panel 2 of Example 4 was as small as 20 mV, and the residual DC voltage value after 100-hour exposure with the backlight was 30 mV, which showed a little increase (deterioration) from the initial residual DC voltage value.

Furthermore, the initial VHR of the switchable mirror panel 2 of Example 4 was 98.3%, and the VHR after 100-hour backlight exposure was 97.4%. The VHR was kept at a high value with little change between before and after the backlight exposure.

As described, the switchable mirror panel 2 of Example 4 had a low residual DC voltage value and a high VHR similarly to those of the liquid crystal panel 1 of Example 1. The switchable mirror panel 2 of Example 4 contained, in addition to the tolan liquid crystal compound, a vertical alignment polymer including a saturated aliphatic functional group at a side chain terminal. This presumably suppressed the n-ninteraction between the alignment films 11 and radicals and ions derived from the tolan liquid crystal compound in the liquid crystal layer 30 to achieve a low residual DC voltage value and a high VHR both at the initial stage and after backlight exposure. The switchable mirror display 3 of Example 4 included the liquid crystal display part 2a between the switchable mirror panel 2 and the backlight 60. This configuration presumably enabled UV light emitted from the backlight 60 to be effectively absorbed by the liquid crystal display part 2a to slow down the speed of radicalization and ionization of the tolan liquid crystal compound in the switchable mirror panel 2 of Example 4. This is presumably another reason for achieving a low residual DC voltage value and a high VHR.

### REFERENCE SIGNS LIST

1: Liquid crystal panel
1a: Liquid crystal panel for display
2: Switchable mirror panel
2a: Liquid crystal display part
3: Switchable mirror display
10: First substrate
10a, 20a: Substrate
10b: Active substrate
11: Vertical alignment film
11a: Alignment film
20: Second substrate
20b: Color filter substrate
30, 30a: Liquid crystal layer
40: Reflective polarizing plate
50, 50a, 50b: Absorptive polarizing plate
60: Backlight

1. A liquid crystal panel comprising:
a first substrate;
a second substrate;
a liquid crystal layer held between the first substrate and the second substrate; and
a vertical alignment film disposed on a liquid crystal layer side of each of the first substrate and the second substrate,
the liquid crystal layer containing a liquid crystal material with a negative anisotropy of dielectric constant,
the liquid crystal material containing a tolan liquid crystal compound,
the vertical alignment film containing a vertical alignment polymer that includes a main chain and a side chain,
the side chain including a saturated aliphatic functional group at a terminal.

2. The liquid crystal panel according to claim 1,
wherein the tolan liquid crystal compound is a compound represented by a formula (T): 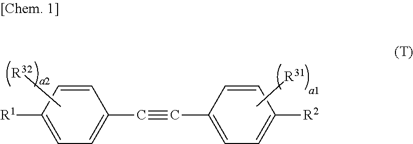
wherein R¹ and R² are each independently a group represented by —(O)_{b}—R⁴; R³¹ and R³² are each independently a halogen group; R⁴ is a C1-C40 aliphatic group, a C6-C40 aromatic group, a cyano group, or an isothiocyanate group; a1 and a2 are each independently an integer of 0 to 4; and b is 0 or 1.

3. The liquid crystal panel according to claim 2,
wherein, in the formula (T), R¹ and R² are each independently —CH₃, —C₂H₅, —C₃H₇, —C₄H₉, —C₅H₁₁, —C₆H₁₃, —OCH₃, —OC₂H₅, —OC₃H₇, —OC₄H₉, —OC₅H₁₁, —OC₆H₁₃, —C₂H₄CH═CH₂, or —OC₂H₄CH═CH₂; R³¹ and R³² are each independently a fluorine atom; and a1 and a2 are each independently an integer of 0 to 2.

4. The liquid crystal panel according to claim 1,
wherein the tolan liquid crystal compound is at least one selected from the group consisting of liquid crystal compounds represented by formulas (T-1) to (T-5):

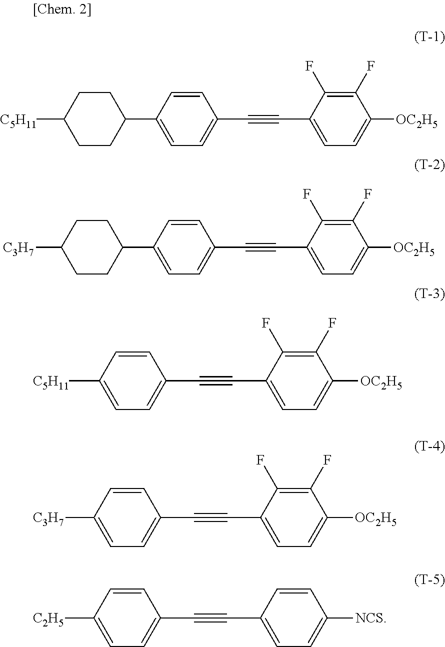

5. The liquid crystal panel according to claim 1,
wherein the liquid crystal material has a birefringence Δn of 0.18 or higher and an anisotropy of dielectric constant Δε of −2.5 or lower.

6. The liquid crystal panel according to claim 1,
wherein the side chain of the vertical alignment polymer includes at least one selected from the group consisting of groups represented by formulas (ZA-1) to (ZA-8): 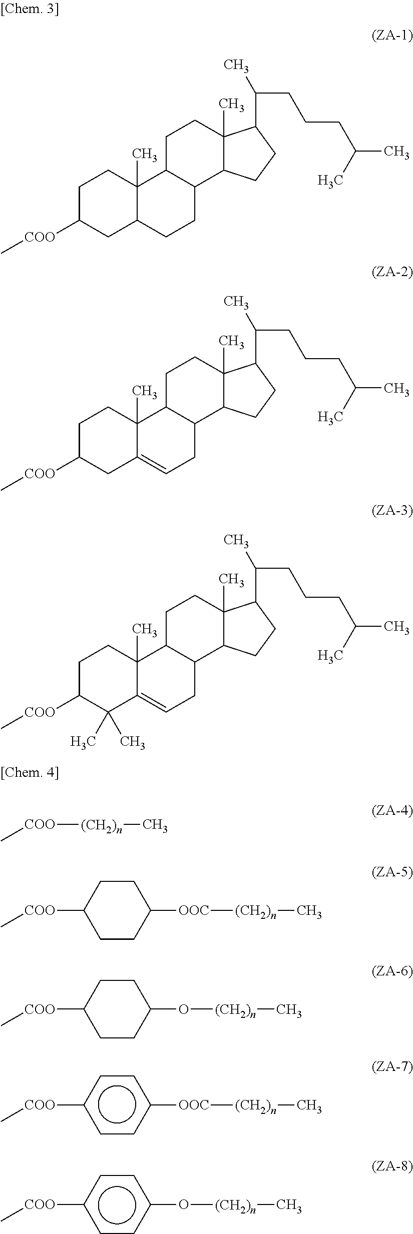
wherein n is an integer of 1 to 17, and the hydrogen atoms are each optionally replaced by a halogen group.

7. The liquid crystal panel according to claim 1,
wherein the main chain of the vertical alignment polymer includes a polyamic acid, a polyimide, a polysiloxane, or polyvinyl.

8. The liquid crystal panel according to claim 1,
wherein the vertical alignment film is a photoalignment film.

9. The liquid crystal panel according to claim 8,
wherein the side chain of the vertical alignment polymer includes at least one selected from the group consisting of cinnamate, azobenzene, chalcone, coumarin, and stilbene groups.

10. The liquid crystal panel according to claim 1,
wherein the liquid crystal panel is a passive driving liquid crystal panel.

11. A switchable mirror panel comprising, in a following order from a back surface side to a front surface side:
a reflective polarizing plate;
the liquid crystal panel according to claim 1; and
an absorptive polarizing plate,
the switchable mirror panel being capable of switching between a transparent mode of transmitting light incident from the back surface side of the reflective polarizing plate through the absorptive polarizing plate and a mirror mode of reflecting light incident from the front surface side of the absorptive polarizing plate by the reflective polarizing plate.

12. A switchable mirror display comprising, in a following order from a back surface side to a front surface side:
a backlight;
a liquid crystal display part; and
the switchable mirror panel according to claim 11,
the liquid crystal display part including an active substrate, a color filter substrate, a liquid crystal layer held between the active substrate and the color filter substrate, and a polarizing plate disposed on a side opposite to the liquid crystal layer of each of the active substrate and the color filter substrate.
